(19) United States
(12) Patent Application Publication
(10) Pub. No.: US 2025/0056654 A1
(43) Pub. Date: Feb. 13, 2025

(54) Discontinuous Reception Operation of a Wireless Communication Device

(71) Applicant: Telefonaktiebolaget LM Ericsson (publ), Stockholm (SE)

(72) Inventors: Jose Luis Pradas, Stockholm (SE); Du Ho Kang, Sollentuna (SE); Andra Mihaela Voicu, Aachen (DE)

(21) Appl. No.: 18/717,616

(22) PCT Filed: Dec. 19, 2022
(86) PCT No.: PCT/SE2022/051204

§ 371 Date: Jun. 7, 2024

Related U.S. Application Data
(60) Provisional application No. 63/291,549, filed on Dec. 20, 2021.

(51) Int. Cl. H04W 76/28; H04W 52/02

(52) U.S. Cl. CPC H04W 76/28; H04W 52/0216

(57) ABSTRACT

A wireless communication device (14) is configured for discontinuous reception. DRX, operation in a wireless communication network (10). The wireless communication device (14) receives a DRX configuration (26) from the wireless communication network (10). The DRX configuration (26) configures the wireless communication device (14) with respective durations of multiple on-duration timers (15) for a DRX group, where the DRX group comprises one or more serving cells of the wireless communication device (14). In some embodiments, the multiple on-duration timers (15) include an inner on-duration timer (15A) and an outer on-duration timer (15B), e.g., where running of the outer on-duration timer (15B) is a prerequisite for starting or re-starting the inner on-duration timer (15A).

### TECHNICAL FIELD

The present application relates generally to a wireless communication device, and relates more particularly to discontinuous reception operation of such a wireless communication device.

### BACKGROUND

After a wireless communication device establishes a radio connection (e.g., Radio Resource Control, RRC, connection) with a radio access network, the wireless communication device monitors a control channel (e.g., a Physical Downlink Control Channel, PDCCH) for control messages directed to the wireless communication device. The control messages may for instance convey scheduling information in the form of downlink assignments or uplink grants for allocating radio resources to the wireless communication device for downlink or uplink data transmission.

To reduce the amount of power that the wireless communication device consumes in monitoring the control channel, the network may configure the wireless communication device with discontinuous reception (DRX) operation. When the wireless communication device is configured with DRX, the network limits the opportunities for transmitting a control message to the wireless communication device on the control channel to certain active time intervals. The wireless communication device then need only monitor the control channel during these active time intervals such that the device monitors the control channel discontinuously in time. Outside of the active time intervals, the wireless communication device can de-activate at least some of its receiver circuitry or otherwise operate in a sleep state so as to conserve power.

Various timers control the active time in DRX operation. When the wireless communication device receives a control message on the control channel, the device starts an inactivity timer. Active time includes the time while the inactivity timer is running, so the device monitors the control channel while the inactivity timer runs. If the inactivity timer expires without receiving any further control message, the device begins to discontinuously monitor the control channel according to a so-called short DRX cycle. At the start of each short DRX cycle, the device starts an on-duration timer. Active time includes the time while the on-duration timer is running, so the device monitors the control channel while the on-duration timer runs. If the on-duration timer expires without receipt of a control message, the device stops monitoring the control channel for the rest of the short DRX cycle. One or more short DRX cycles may recur before a short cycle timer expires. If the device does not receive any control message by the time the short cycle timer expires, the device switches to discontinuously monitoring the control channel according to a so-called long DRX cycle. The long DRX cycle re-uses the same on-duration timer, but the long DRX cycle has a longer duration than the short DRX cycle, meaning that the long DRX cycle provides longer opportunities for the device to sleep in between the active times for monitoring the control channel.

Although DRX significantly reduces device power consumption, challenges nonetheless exist in using DRX in some scenarios, such as in extended Reality (XR) applications or other scenarios where random traffic jitter is present. In these scenarios, for example, increasing the duration of the on-duration timer allows the device to be awake during the entire possible jitter range, e.g., as needed to meet the traffic delay requirements of XR. However, increasing the duration of the on-duration timer in this way jeopardizes the power savings targeted by DRX.

### SUMMARY

According to some embodiments herein, discontinuous reception (DRX) operation of a wireless communication device exploits multiple on-duration timers, e.g., for the same DRX group of serving cell(s). The active time during which the wireless communication device monitors a control channel may depend on these multiple on-duration timers. By exploiting multiple on-duration timers, some embodiments advantageously provide DRX operation suitable for extended Reality (XR) applications or other scenarios where random traffic jitter is present. Some embodiments for example provide DRX operation that meets the traffic delay requirements of XR while also preserving the power conservation advantages of DRX.

For example, in some embodiments, the multiple on-duration timers may include an inner on-duration timer and an outer on-duration timer, e.g., where one or more on-duration periods defined by the inner on-duration timer are nested inside of an any given on-duration period defined by the outer on-duration timer. In one such embodiment, the active time includes time while the inner on-duration timer is running, but the starting and/or stopping of the inner on-duration timer is conditioned on the outer on-duration timer, e.g., such that the inner on-duration timer cannot be started unless the outer on-duration timer is running and/or the inner on-duration timer is stopped if the outer on-duration timer is stopped. Alternatively or additionally, the active time includes at least time while the inner on-duration timer and the outer on-duration timer are running simultaneously. Regardless, in embodiments that employ such an inner on-duration timer and an outer on-duration timer, the duration of the outer on-duration timer may be “fit” to span the traffic jitter range (and the duration of an outer DRX cycle may be “fit” to the periodic nature of the targeted traffic). But, rather than continuously monitoring the control channel throughout the traffic jitter range (while the on-duration timer is running in an outer DRX cycle), the device may only discontinuously monitor the control channel according to one or more inner DRX cycles whose on-duration is defined by the inner on-duration timer. The embodiments in this case thereby provide short data delay during the traffic jitter range while at the same time avoiding continuous monitoring during the traffic jitter range so as to maintain the power conservation benefits of DRX operation.

More particularly, embodiments herein include a method performed by a wireless communication device for discontinuous reception, DRX, operation in a wireless communication network. The method comprises receiving, from the wireless communication network, a DRX configuration that configures the wireless communication device with respective durations of multiple on-duration timers for a DRX group, wherein the DRX group comprises one or more serving cells of the wireless communication device.

In some embodiments, the method further comprises monitoring a downlink control channel on the one or more serving cells if the DRX group is in active time. In this case, the active time depends on the multiple on-duration timers. In one or more of these embodiments, the active time for the DRX group includes at least time while the multiple on-duration timers are running simultaneously. In one or more of these embodiments, the active time for the DRX group includes time while the multiple on-duration timers are running. In one or more of these embodiments, the multiple on-duration timers include an inner on-duration timer and an outer on-duration timer, and the active time for the DRX group includes at least time while the inner on-duration timer is running. In one or more of these embodiments, running of the outer on-duration timer is a prerequisite for starting or re-starting the inner on-duration timer. In one or more of these embodiments, stopping or expiry of the outer on-duration timer triggers prohibiting starting or re-starting the inner on-duration timer and starting or re-starting of the outer on-duration timer triggers allowing starting or re-starting the inner on-duration timer. In one or more of these embodiments, stopping or expiry of the outer on-duration timer triggers stopping of the inner on-duration timer. In one or more of these embodiments, stopping or expiry of the outer on-duration timer triggers stopping of an inactivity timer, and the active time for the DRX group also includes at least time while the inactivity timer is running. In one or more of these embodiments, receipt by the wireless communication device of a stop indication from the wireless communication network triggers stopping of one or more of the inner on-duration timer, the outer on-duration timer, and an inactivity timer.

In some embodiments, the multiple on-duration timers include an inner on-duration timer and an outer on-duration timer. In one or more of these embodiments, the method further comprises, while the outer on-duration timer is running, monitoring a downlink control channel on the one or more serving cells discontinuously at times when the inner on-duration timer runs. In one or more of these embodiments, the duration of the inner on-duration timer is shorter than the duration of the outer on-duration timer. In one or more of these embodiments, an on-duration period of an inner DRX cycle has a duration equal to the duration of the inner on-duration timer, an on-duration period of an outer DRX cycle has a duration equal to the duration of the outer on-duration timer, and the on-duration period of an outer DRX cycle spans a set of multiple inner DRX cycles. In one or more of these embodiments, the DRX configuration configures different durations of the inner on-duration timer for at least some inner DRX cycles in the set. In one or more of these embodiments, the DRX configuration configures at least some of the inner DRX cycles in the set to have different durations. In one or more of these embodiments, the method further comprises starting the outer on-duration timer if one or more outer conditions are each fulfilled, and starting the inner on-duration timer if one or more inner conditions are each fulfilled. In this case, the one or more inner conditions include a condition that the outer on-duration timer is running.

In some embodiments, the multiple on-duration timers include multiple inner on-duration timers and also include an outer on-duration timer. In this case, an on-duration period of an outer DRX cycle has a duration equal to the duration of the outer on-duration timer, an on-duration period of an outer DRX cycle spans a set of multiple inner DRX cycles, and on-duration periods of at least some of the multiple inner DRX cycles in the set have different durations corresponding to the durations of the multiple inner on-duration timers.

In some embodiments, the multiple on-duration timers include an inner on-duration timer and an outer on-duration timer. In this case, the active time further depends on an inactivity timer, and the active time for the DRX group includes at least time while the inner and outer on-duration timers are running simultaneously, and time while the outer on-duration timer and the inactivity timer are running simultaneously.

In some embodiments, the DRX configuration is specific to a certain type of service or traffic. In one or more of these embodiments, the certain type of service is an extended Reality, XR, service.

In some embodiments, the method further comprises receiving a downlink control message on the downlink control channel based on said monitoring.

Other embodiments herein include a method performed by a wireless communication device for discontinuous reception, DRX, operation in a wireless communication network. The method comprises starting or re-starting an inner on-duration timer if an outer on-duration timer is running, and monitoring a downlink control channel at least while the inner on-duration timer is running.

In some embodiments, monitoring comprises monitoring the downlink control channel on one or more serving cells in a DRX group if the DRX group is in active time. In this case, the active time includes at least time while the inner on-duration timer is running. In one or more of these embodiments, the active time for the DRX group also includes at least time while an inactivity timer is running.

In some embodiments, the method further comprises stopping the inner on-duration timer upon expiry of the outer on-duration timer.

In some embodiments, the method further comprises stopping an inactivity timer upon expiry of the outer on-duration timer.

In some embodiments, monitoring comprises, while the outer on-duration timer is running, monitoring the downlink control channel discontinuously at times when the inner on-duration timer runs.

In some embodiments, a duration of the inner on-duration timer is shorter than a duration of the outer on-duration timer.

In some embodiments, an inner DRX cycle comprises an on-duration period and an off-duration period. In this case, the on-duration period of an inner DRX cycle has a duration equal to a duration of the inner on-duration timer, an outer DRX cycle comprises an on-duration period and an off-duration period, the on-duration period of an outer DRX cycle has a duration equal to a duration of the outer on-duration timer, and the on-duration period of an outer DRX cycle spans a set of multiple inner DRX cycles.

In some embodiments, the method further comprises providing user data, and forwarding the user data to a host computer via the transmission to a base station.

Other embodiments herein include a method performed by a network node of configuring a wireless communication device for discontinuous reception, DRX, operation in a wireless communication network. The method comprises transmitting, to the wireless communication device, a DRX configuration that configures the wireless communication device with respective durations of multiple on-duration timers for a DRX group. In this case, the DRX group comprises one or more serving cells of the wireless communication device.

In some embodiments, the multiple on-duration timers govern an active time, for the DRX group, during which the wireless communication device is to monitor a downlink control channel on the one or more serving cells. In one or more of these embodiments, the active time for the DRX group includes at least time while the multiple on-duration timers are running simultaneously. In one or more of these embodiments, the active time for the DRX group includes time while the multiple on-duration timers are running. In one or more of these embodiments, the multiple on-duration timers include an inner on-duration timer and an outer on-duration timer. In this case, the active time for the DRX group includes at least time while the inner on-duration timer is running. In one or more of these embodiments, running of the outer on-duration timer is a prerequisite for starting or re-starting the inner on-duration timer. In one or more of these embodiments, stopping or expiry of the outer on-duration timer triggers prohibiting starting or re-starting the inner on-duration timer and starting or re-starting of the outer on-duration timer triggers allowing starting or re-starting the inner on-duration timer. In one or more of these embodiments, stopping or expiry of the outer on-duration timer triggers stopping of the inner on-duration timer. In one or more of these embodiments, stopping or expiry of the outer on-duration timer triggers stopping of an inactivity timer. In this case, the active time for the DRX group also includes at least time while the inactivity timer is running. In one or more of these embodiments, the method further comprises transmitting, to the wireless communication device, a stop indication that indicates the wireless communication device is to stop one or more of the inner on-duration timer, the outer on-duration timer, and an inactivity timer.

In some embodiments, the multiple on-duration timers include an inner on-duration timer and an outer on-duration timer. In one or more of these embodiments, while the outer on-duration timer is running, the wireless communication device is to monitor a downlink control channel on the one or more serving cells discontinuously at times when the inner on-duration timer runs. In one or more of these embodiments, the duration of the inner on-duration timer is shorter than the duration of the outer on-duration timer. In one or more of these embodiments, an on-duration period of an inner DRX cycle has a duration equal to the duration of the inner on-duration timer. In this case, an on-duration period of an outer DRX cycle has a duration equal to the duration of the outer on-duration timer, and the on-duration period of an outer DRX cycle spans a set of multiple inner DRX cycles. In one or more of these embodiments, the DRX configuration configures different durations of the inner on-duration timer for at least some inner DRX cycles in the set. In one or more of these embodiments, the DRX configuration configures at least some of the inner DRX cycles in the set to have different durations. In one or more of these embodiments, the outer on-duration timer is to be started if one or more outer conditions are each fulfilled, and the inner on-duration timer is to be started if one or more inner conditions are each fulfilled, wherein the one or more inner conditions include a condition that the outer on-duration timer is running.

In some embodiments, the multiple on-duration timers include multiple inner on-duration timers and also include an outer on-duration timer. In this case, an on-duration period of an outer DRX cycle has a duration equal to the duration of the outer on-duration timer, an on-duration period of an outer DRX cycle spans a set of multiple inner DRX cycles, and the on-duration periods of at least some of the multiple inner DRX cycles in the set have different durations corresponding to the durations of the multiple inner on-duration timers.

In some embodiments, the multiple on-duration timers include an inner on-duration timer and an outer on-duration timer. In this case, the active time further depends on an inactivity timer, and the active time for the DRX group includes at least time while the inner and outer on-duration timers are running simultaneously, and time while the outer on-duration timer and the inactivity timer are running simultaneously.

In some embodiments, the DRX configuration is specific to a certain type of service or traffic. In one or more of these embodiments, the certain type of service is an extended Reality, XR, service.

In some embodiments, the method further comprises scheduling a downlink control message to the wireless communication device on the downlink control channel based on the DRX configuration and transmitting the scheduled downlink control message to the wireless communication device.

Other embodiments herein include corresponding apparatus, computer programs, and carriers of those computer programs.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2A is a block diagram of some embodiments where multiple on-duration timers are hierarchically related to one another.

FIG. 2B is a block diagram of inner and outer on-duration timers according to some embodiments.

FIG. 2C is a block diagram of some embodiments in which an active time is defined as including (at least) time while the outer on-duration timer and the inner on-duration timer are running simultaneously.

FIG. 2D is a block diagram of some embodiments where the inner on-duration timer is (re) started based on the outer on-duration timer.

FIG. 2E is a block diagram of other embodiments where the inner on-duration timer is stopped based on the outer on-duration timer.

FIG. 2F is a block diagram of inner and outer on-duration timers according to yet other embodiments.

FIG. 3 is a block diagram of UE DL monitoring operation according to Long and the Short DRX cycles according to some embodiments.

FIG. 4A is a block diagram showing a long drx-onDurationTimer according to some embodiments.

FIG. 4B is a block diagram showing a short drx-onDurationTimer according to other embodiments.

FIG. 5A is a chart of the 99^{th} percentile traffic delay at a UE, for two Long DRX configurations according to some embodiments.

FIG. 5B is a chart of the power saving gain at a UE, for two Long DRX configurations according to some embodiments.

FIG. 6 is a block diagram of DL traffic arrival and DL time slots for which a UE is awake, for the proposed Inner/Outer DRX according to some embodiments.

FIG. 7A is a chart of the 99^{th} percentile traffic delay at a UE, for the proposed Inner/Outer DRX, according to some embodiments.

FIG. 7B is a chart of the power saving gain at a UE, for the proposed Inner/Outer DRX, according to some embodiments.

FIG. 8 is a block diagram of an Outer and Inner DRX cycle according to some embodiments.

FIG. 9 is a block diagram of Inner/Outer DRX when the Outer-onDurationTimer expires, but the Inner-Inactivity Timer is still running according to some embodiments.

FIG. 10 is a block diagram of some embodiments where the Outer-onDurationTimer and/or Inner-onDurationTimer and/or Inner-InactivityTimer can be terminated in one or more Outer DRX cycles.

FIG. 11 is a logic flow diagram of inner and outer DRX timer operation according to some embodiments.

FIG. 12 is a logic flow diagram of inner and outer DRX timer operation according to other embodiments.

FIG. 13 is a logic flow diagram of a method performed by a network node of configuring a wireless communication device for discontinuous reception, DRX, operation in a wireless communication network, according to some embodiments.

FIG. 14 is a logic flow diagram of a method performed by a wireless communication device for discontinuous reception, DRX, operation in a wireless communication network according to some embodiments.

FIG. 15 is a block diagram of a wireless communication device according to some embodiments.

FIG. 16 is a block diagram of a network node according to some embodiments.

FIG. 17 is a block diagram of a communication system in accordance with some embodiments

FIG. 18 is a block diagram of a user equipment according to some embodiments.

FIG. 19 is a block diagram of a network node according to some embodiments.

FIG. 20 is a block diagram of a host according to some embodiments.

FIG. 21 is a block diagram of a virtualization environment according to some embodiments.

FIG. 22 is a block diagram of a host communicating via a network node with a UE over a partially wireless connection in accordance with some embodiments.

### DETAILED DESCRIPTION

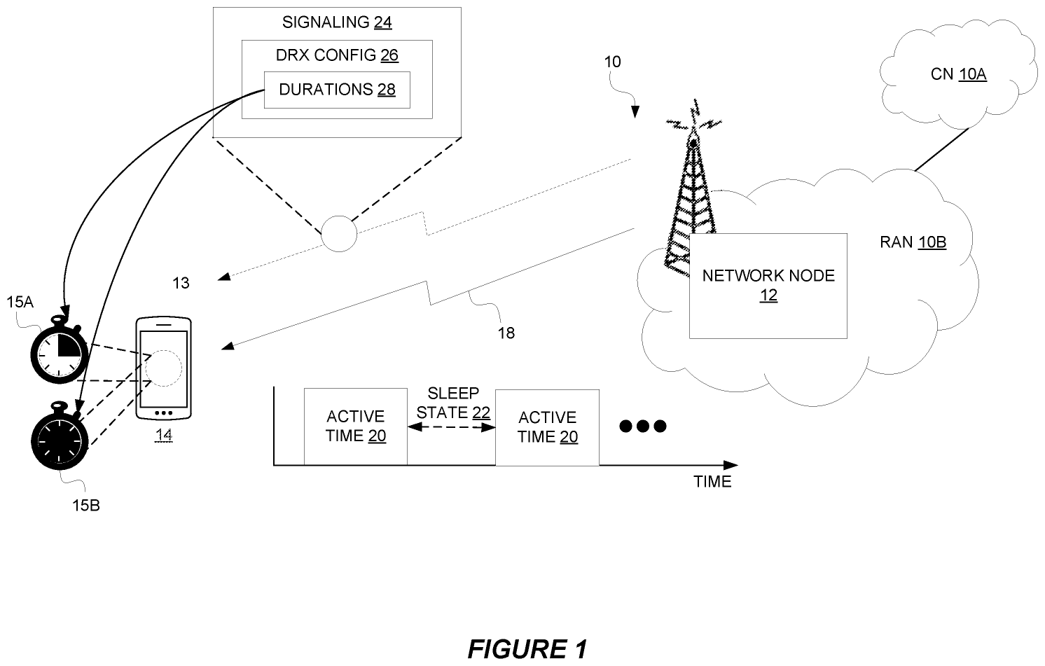

FIG. 1 shows a wireless communication network 10 (e.g., a 5G network) according to some embodiments. The network 10 includes a core network (CN) 10A (e.g., a 5G Core, 5GC) and a radio access network (RAN) 10B (e.g., a New Radio, NR, network). The RAN 10B includes one or more network nodes 12 (e.g., one or more base stations, such as one or more gNBs) for providing radio access to wireless communication devices (e.g., user equipments, UEs), one of which is shown as wireless communication device 14. Via this radio access, a wireless communication device 14 connects to the CN 10A, which in turn may provide the wireless communication device 14 with access to one or more external networks (not shown), such as the Internet.

The wireless communication device 14 is configured to monitor a control channel 18 (e.g., a Physical Downlink Control Channel, PDCCH) for control messages directed to the wireless communication device 14. The wireless communication device 14 may monitor this control channel 18, for instance, while the wireless communication device 14 is in a connected mode in which the wireless communication device 14 has established a radio connection (e.g., a Radio Resource Control, RRC, connection) with the RAN 10B. In these and other cases, the control messages for which the wireless communication device 14 monitors the control channel 18 may include messages that convey scheduling information for the wireless communication device 14, e.g., in the form of downlink assignments or uplink grants that allocate radio resources to the wireless communication device 14 for downlink or uplink data transmission. Monitoring the control channel 18 may involve, for instance, the wireless communication device 14 (blindly) decoding any control messages received on the control channel 18 (e.g., using one or more radio network temporary identities, RNTIs, assigned to the wireless communication device 14) in order to determine whether the control messages are directed to the wireless communication device 14.

In some embodiments, the wireless communication device 14 may be configured (e.g., by RRC) for discontinuous reception (DRX) operation that controls the device's control channel monitoring activity, e.g., when in connected mode. When configured with DRX, the wireless communication device 14 monitors the control channel 18 discontinuously in time. As shown in this regard, the wireless communication device 14 generally monitors the control channel 18 during a so-called active time 20, which may periodically or occasionally recur. The wireless communication device 14 does not monitor the control channel 18 outside of this active time 20. Instead, outside of the active time 20, the wireless communication device 14 may operate in a sleep state 22, e.g., within which the wireless communication device 14 at least partially de-activates its receiver circuitry so as to conserve power.

According to some embodiments herein, DRX operation of the wireless communication device 14 exploits multiple on-duration timers 15, shown in FIG. 1 as including at least on-duration timer 15A and on-duration timer 15B. The active time 20 during which the wireless communication device 14 monitors the control channel 18 depend on these multiple on-duration timers 15. For example, the active time 20 may include (at least) time while the multiple on-duration timers 15 are running simultaneously. In any event, by exploiting multiple on-duration timers 15, some embodiments advantageously provide DRX operation suitable for extended Reality (XR) applications or other scenarios where random traffic jitter is present. Some embodiments for example provide DRX operation that meets the traffic delay requirements of XR while also preserving the power conservation advantages of DRX.

In some embodiments, different sets of DRX parameters are defined for different groups of one or more serving cells of the wireless communication device 14, where each such group is referred to as a DRX group. Notably, in these embodiments, the multiple on-duration timers 15 are defined even for the same DRX group. That is, the DRX parameters defined for any single DRX group includes the multiple on-duration timers 15. In this case, then, the active time 20 for monitoring the control channel on the serving cell(s) of a certain DRX group is dependent on multiple on-duration timers 15 rather than a single on-duration timer. For example, the active time for the DRX group may include (at least) time while the multiple on-duration timers 15 are running simultaneously.

Regardless, the wireless communication network 10 may control the respective durations of the on-duration timers 15. For example, as shown in FIG. 1, a network node 12 in the wireless communication network 10 may transmit a DRX configuration (DRX) 26 to the wireless communication device 14. The DRX configuration 26 may for instance be transmitted via signaling 24, e.g., in the form of Radio Resource Control (RRC) signaling. The DRX configuration 26 configures the wireless communication device 14 with respective durations 28 of the multiple on-duration timers 15, e.g., for a certain DRX group. In some embodiments, the DRX configuration 26 is specific to a certain type of service or traffic, e.g., an XR service or XR traffic.

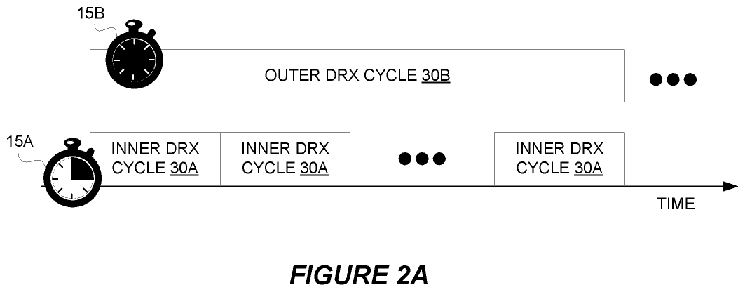

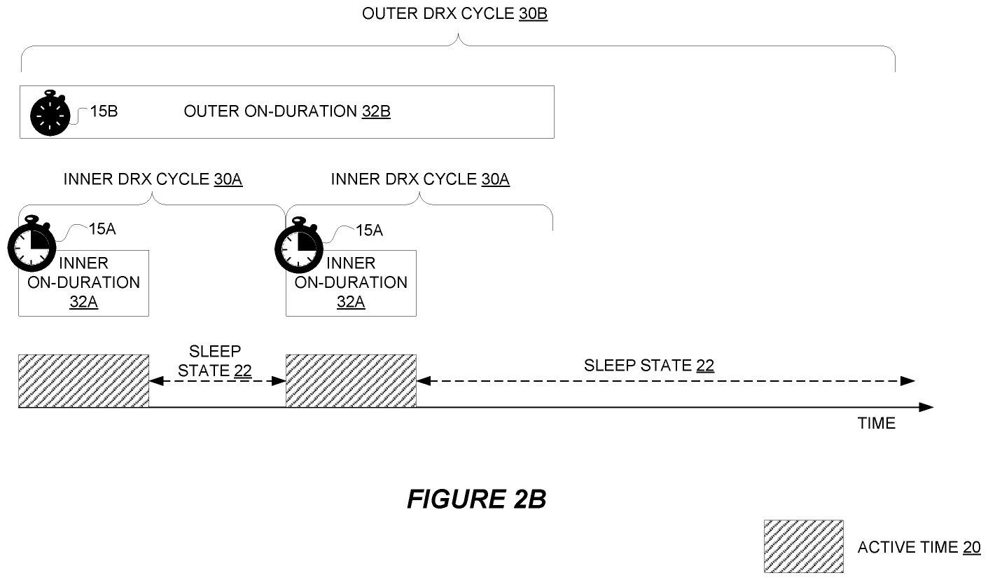

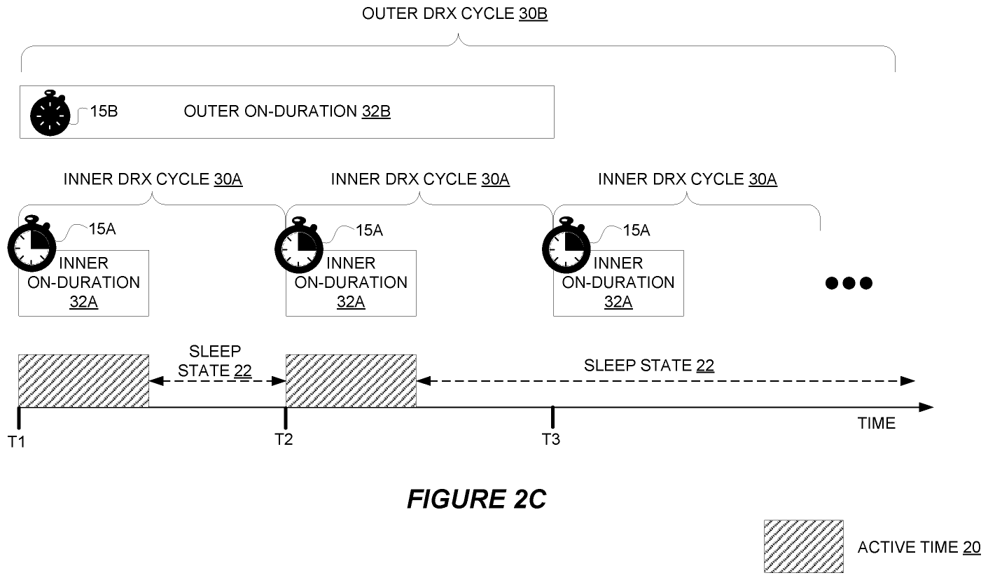

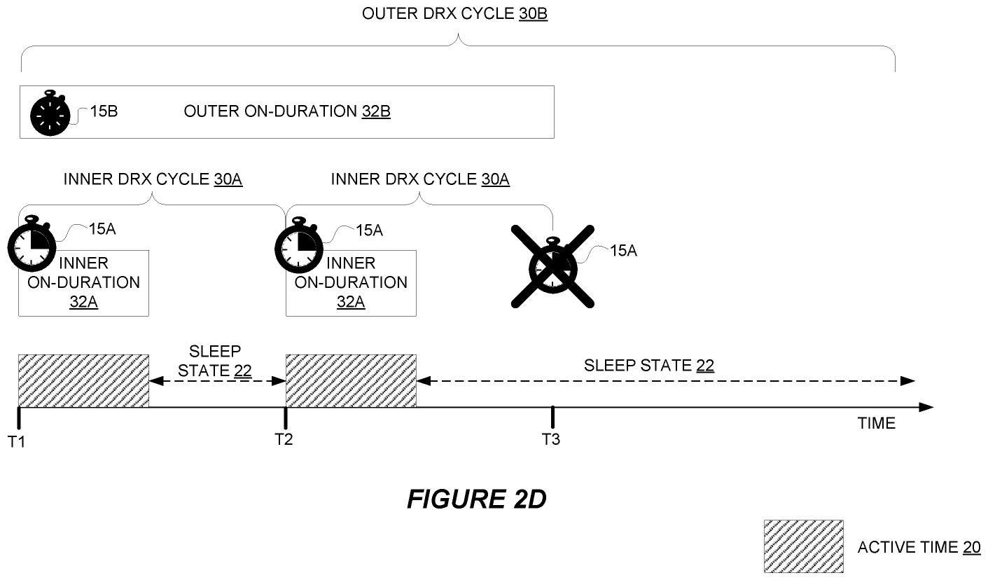

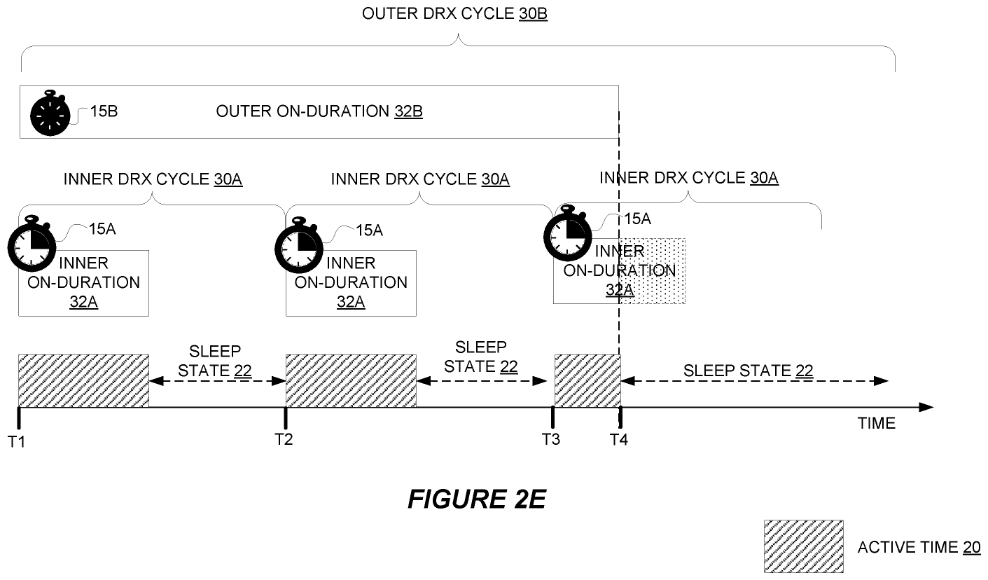

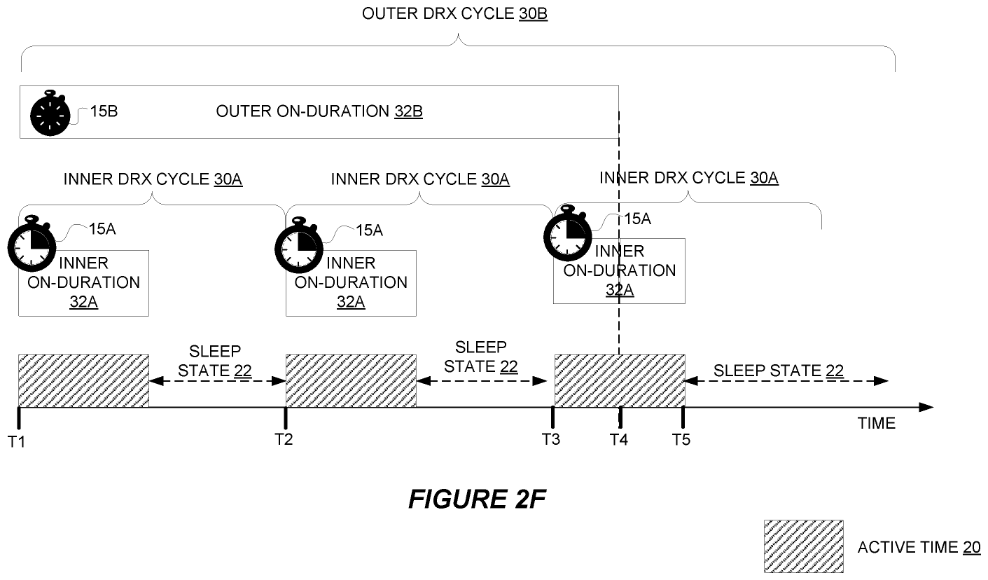

FIG. 2A shows some embodiments where the multiple on-duration timers 15 are hierarchically related to one another, e.g., for nested or hierarchically related DRX cycles. As shown, on-duration timer 15A is a so-called inner on-duration timer for defining an on-duration period 32A of inner DRX cycle(s) 30A and on-duration timer 15B is a so-called outer on-duration timer for defining an on-duration period 32B of outer DRX cycle(s) 30B.

Any given inner DRX cycle 30A may at least partially overlap in time with at least one outer DRX cycle 30B, as shown. In some embodiments, for instance, any given outer DRX cycle 30B spans one or more inner DRX cycles 30A in time. In these and other embodiments, the duration of the inner on-duration timer 15A may be shorter than the duration of the outer on-duration timer 15B. An inner DRX cycle 30A is effectively nested within an outer DRX cycle 30B in the sense that the inner DRX cycle 30A depends upon the outer DRX cycle 30B. So nested, the active time 20 depends upon both the outer DRX cycle 30B and the inner DRX cycle 30A, so as to depend upon both the outer on-duration timer 15B and the inner on-duration timer 15A.

FIG. 2B illustrates one example. As shown, the outer on-duration timer 15B defines an outer on-duration period 32B of an outer DRX cycle 30B and the inner on-duration timer 15A defines an inner on-duration period 32A of an inner DRX cycle 30A. That is, the inner on-duration period 32A of an inner DRX cycle 30A has a duration equal to the duration of the inner on-duration timer 15A, and the outer on-duration period 32B of an outer DRX cycle 30B has a duration equal to the duration of the outer on-duration timer 15B. As shown, the outer on-duration period 30B of an outer DRX cycle 30B spans a set of multiple inner DRX cycles 30A. The active time 20 as shown includes time when the outer on-duration period 32B of the outer DRX cycle 30B overlaps with the inner on-duration period 32A of the inner DRX cycle 30A. In other words, the active time 20 includes (at least) time while both the outer on-duration timer 15B and the inner on-duration timer 15A are running simultaneously. Effectively, then, while the outer on-duration timer 15B is running, the wireless communication device 12 monitors the downlink control channel 18 (e.g., on the one or more serving cells of a certain DRX group) discontinuously at times when the inner on-duration timer 15A runs.

There are different possible approaches for realizing this. In a first approach, the active time 20 is defined as a function of both the outer DRX cycle 30B and the inner DRX cycle 30A, e.g., as a function of whether or not both the outer on-duration timer 15B and the inner on-duration timer 15A are running simultaneously. In a second approach, by contrast, the active time 20 is defined as a function of only the inner DRX cycle 30A, e.g., as a function of whether the inner on-duration timer 15A is running, without regard to whether the outer on-duration timer 15B is running. In this second approach, though, the inner on-duration timer 15A may be controlled (e.g., (re) started and/or stopped) based on the outer on-duration timer 15B.

FIG. 2C shows one example of the first approach in which the active time 20 is defined as including (at least) time while the outer on-duration timer 15B and the inner on-duration timer 15A are running simultaneously. In this example, the inner on-duration timer 15A is periodically restarted without regard to whether or not the outer on-duration timer 15B is running. As shown, then, the inner on-duration timer 15A is periodically restarted at times T1, T2, and T3. So, even though the outer on-duration timer 15B is not running at time T3 (having just stopped), the inner on-duration timer 15A is still restarted at time T3. However, starting of the inner on-duration timer 15A at time T3 does not trigger active time 20 because the outer on-duration timer 15B is not running simultaneously with the inner on-duration timer 15A.

FIG. 2D shows one example of the second approach, where the inner on-duration timer 15A is (re) started based on the outer on-duration timer 15B. In this example, running of the outer on-duration timer 15B is a prerequisite for starting or re-starting the inner on-duration timer 15A. In other words, stopping or expiry of the outer on-duration timer 15B triggers prohibiting starting or re-starting the inner on-duration timer 15A and starting or re-starting of the outer on-duration timer 15B triggers allowing starting or re-starting the inner on-duration timer 15A. As shown, then, the inner on-duration timer 15A is scheduled to be started at time T1. As part of the decision of whether to start the inner on-duration timer 15A at time T1 as scheduled, the wireless communication device 14 checks whether or not the outer on-duration timer 15B is running. Because the outer on-duration timer 15B is indeed running at time T1 (having just started), the wireless communication device 14 decides to start the inner on-duration timer 15A as scheduled. While this inner on-duration timer 15A is running, the wireless communication device 14 is deemed to be in active time 20, so the wireless communication device 14 monitors the downlink control channel 18. The inner on-duration timer 15A expires some time later, at which point the wireless communication device 14 transitions to the sleep state 22. The inner on-duration timer 15 however is scheduled to be re-started at time T2. As before, the wireless communication device 14 checks whether or not the outer on-duration timer 15B is running, as a pre-requisite for restarting the inner on-duration timer 15A at time T2. Since the outer on-duration timer 15B is in fact running at time T2, the wireless communication device 14 restarts the inner on-duration timer 15A as scheduled at time T2. Again the inner on-duration timer 15A expires some time later and then is scheduled to be re-started at time T3. However, at time T3, the outer on-duration timer 15B is no longer running (having just stopped). So, this time, the wireless communication device 14 decides not to restart the inner on-duration timer 15A and so stays in the sleep state 22.

Generally, as shown by this example, the outer on-duration timer 15B in some embodiments is (re) started if one or more outer conditions are each fulfilled. And the inner on-duration timer 15A is (re) started if one or more inner conditions are each fulfilled. And, in this case, the one or more inner conditions include that the outer on-duration timer is running.

FIG. 2E shows another example of the second approach, where the inner on-duration timer 15A is stopped based on the outer on-duration timer 15B. Compared to FIG. 2D, the outer on-duration period 32B doesn't end until after time T3. Because of this, the wireless communication device 14 restarts the inner on-duration timer 15A at time T3. However, the outer on-duration timer 15B expires at time T4, before the inner on-duration timer 15A expires. In this example, then, the stopping or expiration of the outer on-duration timer 15B at time T4 triggers stopping of the inner on-duration timer 15A at time T4. The active time 20 therefore occurs between time T3 and time T4, even though the inner on-duration timer 15A would have continued to run past time T4 had the inner on-duration timer 15B not expired.

Note, though, that some embodiments herein may operate consistently with the example in FIG. 2D, but not with the example in FIG. 2E. In this case, then, the inner on-duration timer 15A is (re) started only if the outer on-duration timer 15B is running, but the inner on-duration timer 15A is not stopped upon stopping or expiration of the outer on-duration timer 15B. That is, the inner on-duration timer 15A is allowed to continue running, even if the outer on-duration timer 15B stops or expires, but the inner on-duration timer 15A will not be allowed to (re) start thereafter until the outer on-duration timer 15B is restarted. FIG. 2F shows one example of this. As shown, expiration of the outer on-duration timer 15B at time T4 does not trigger stopping of the inner on-duration timer 15A. Instead, the inner on-duration timer 15A is allowed to continue running until expiration at time T5. This extends the active time 20 to include not only the time between time T3 and T4, when both the outer on-duration timer 15B and the inner on-duration timer 15A are running simultaneously, but also the time between time T4 and time T5, when only the inner on-duration timer 15A is running.

Although the above examples have focused on the on-duration timers 15A, 15B, embodiments herein may also exploit an inactivity timer. Such an inactivity timer may be started upon receipt of a control message on the downlink control channel 18. In this case, the active time 20 may further depend on the inactivity timer. For example, in some embodiments, such as in the example of FIG. 2C, the active time 20 may also include time while the outer on-duration timer 15B and the inactivity timer are running simultaneously. Alternatively, in other embodiments, such as in the examples of FIGS. 2D-2F, the active time 20 may also include time while the inactivity timer is running, without regard to whether the outer on-duration timer 15B is running. In these embodiments, though, stopping or expiration of the outer on-duration timer 15B may tigger stopping of the inactivity timer.

Note also that, in some embodiments, the wireless communication network 10 may trigger stoppage of the outer on-duration timer 15B, the inner on-duration timer 15A, and/or the inactivity timer via a stop indication transmitted to the wireless communication device 14. In this case, if the wireless communication device 14 receives a stop indication from the wireless communication network 10, the wireless communication device 14 is to stop the outer on-duration timer 15B, the inner on-duration timer 15A, and/or the inactivity timer.

In some embodiments, the length of the outer DRX cycle 30B is matched to the periodicity of the expected traffic arrival, e.g., where communication of that traffic would trigger scheduling message(s) on the downlink control channel 18. And the length of the outer DRX cycle 30B may be matched to the traffic jitter range. So configured, rather than continuously monitoring the control channel 18 throughout the traffic jitter range (while the outer on-duration timer 15B is running in the outer DRX cycle 30B), the wireless communication device 12 only discontinuously monitors the downlink control channel 18 according to inner DRX cycle(s) 30A whose on-duration is defined by the inner on-duration timer 15A. The embodiments in this case thereby provide short data delay during the traffic jitter range while at the same time avoiding continuous monitoring during the traffic jitter range so as to maintain the power conservation benefits of DRX operation.

Note further that, in some embodiments, the inner DRX cycle and the outer DRX cycle may correspond to or be based upon the short DRX cycle and the long DRX cycle in existing approaches, except that the cycles have separate on-duration timers, are allowed to overlap in time, and are related to one another hierarchically as described above.

Consider now examples of some embodiments herein in the following context of a service, such as extended reality (XR) applications, whose traffic arrival is overall periodic, but suffers from jitter around the periodicity. In these examples, the wireless communication device 14 may be exemplified as a user equipment (UE), and the network node 12 may be exemplified as a gNB,

XR applications typically generate traffic flows which are in principle periodic, e.g., video traffic with 30, 60, 90, or 120 fps. However, the traffic arrival moment at the radio access network (RAN) is affected by jitter around the periodicity value, due to processing of the frames at the application (e.g., for compression), as well as transmission through the Core Network. This is modelled in 3GPP, by assuming that each data frame arriving at the RAN has a random jitter of [−4; +4] ms (optionally [−5; +5] ms) around the main periodicity. The probability of the jitter value within this interval is given by a truncated Gaussian distribution with mean 0 ms and standard deviation 2 ms.

XR traffic has strict delay requirements, in terms of packet delay budget (PDB). This is the maximum tolerable delay for a packet to be transmitted from a gNB to a UE. The PDB value depends on the XR traffic type and is overall between 5 ms and 30 ms.

Some embodiments address shortcomings of standard DRX features (i.e., Long DRX and optional Short DRX) that are not suitable for coping with random traffic jitter, such that both a short data delay and low power consumption are experienced at the UE. Consider these shortcomings below.

The standard DRX framework heretofore consists of two different types of DRX cycles with different periods: a Long DRX cycle and an optional Short DRX cycle. In principle, the Short DRX cycle results in the UE monitoring the downlink (DL) more often than when the UE operates according to the Long DRX cycle. Entering the Long or Short DRX cycles occurs as follows. If the Short DRX cycle is not configured, the UE enters the Long DRX cycle after the inactivity timer expires, i.e., when there are no DL or uplink (UL) transmissions for a period of time. If the optional Short DRX cycle is configured, the UE enters the Short cycle (by starting/restarting the Short cycle timer) after the DRX inactivity timer expires, or after the reception of a DRX Command Medium Access Control (MAC) Control Element (CE). If the Short DRX cycle is configured and the Short cycle timer expires or a Long DRX Command MAC CE is received, the UE enters the Long DRX cycle.

DRX is controlled by the following main parameters:
drx-onDurationTimer: the duration at the beginning of a DRX cycle;
drx-SlotOffset: the delay before starting the drx-onDurationTimer;
drx-InactivityTimer: the duration after the Physical Downlink Control Channel (PDCCH) occasion in which a PDCCH indicates a new UL or DL transmission for the MAC entity;
drx-Retransmission TimerDL (per DL Hybrid Automatic Repeat ReQuest (HARQ) process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycle Timer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
ps-Wakeup (optional): the configuration to start associated drx-onDurationTimer in case DCP is monitored but not detected;
ps-TransmitOtherPeriodicCSI (optional): the configuration to report periodic Channel State Information (CSI) that is not Layer 1 Reference Signal Received Power (L1-RSRP) on Physical Uplink Control Channel (PUCCH) during the time duration indicated by drx-onDurationTimer in case Downlink Control information of Power saving (DCP) is configured but associated drx-onDurationTimer is not started;
ps-TransmitPeriodicL1-RSRP (optional): the configuration to transmit periodic CSI that is L1-RSRP on PUCCH during the time duration indicated by drx-onDurationTimer in case DCP is configured but associated drx-onDurationTimer is not started.

The DRX configuration heretofore takes the following values:

DRX-Config information element

-- ASN1START
-- TAG-DRX-CONFIG-START

| | |
|---|---|
| DRX-Config ::= | SEQUENCE { |
| drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, ms30, ms40, |
| | ms50, ms60, ms80, ms100, ms200, ms300, ms400, ms500, |
| | ms600, ms800, ms1000, ms1200, ms1600, spare8, spare7, |
| | spare6, spare5, spare4, spare3, spare2, spare1 } |
| | }, |
| drx-InactivityTimer | ENUMERATED { |
| | ms0, ms1, ms2, ms3, ms4, ms5, ms6, ms8, ms10, ms20, ms30, |
| | ms40, ms50, ms60, ms80, ms100, ms200, ms300, ms500, ms750, |
| | ms1280, ms1920, ms2560, spare9, spare8, spare7, spare6, spare5, |
| | spare4, spare3, spare2, spare1}, |
| drx-HARQ-RTT-TimerDL | INTEGER (0..56), |
| drx-HARQ-RTT-TimerUL | INTEGER (0..56), |
| drx-RetransmissionTimerDL | ENUMERATED { |
| | sl0, sl1, sl2, sl4, sl6, sl8, sl16, sl24, sl33, sl40, sl64, sl80, sl96, |
| | sl112, sl128, sl160, sl320, spare15, spare14, spare13, spare12, |
| | spare11, spare10, spare9, spare8, spare7, spare6, spare5, spare4, |
| | spare3, spare2, spare1}, |
| drx-RetransmissionTimerUL | ENUMERATED { |
| | sl0, sl1, sl2, sl4, sl6, sl8, sl16, sl24, sl33, s140, sl64, s180, sl96, |
| | sl112, sl128, sl160, sl320, spare15, spare14, spare13, spare12, |
| | spare11, spare10, spare9, spare8, spare7, spare6, spare5, spare4, |
| | spare3, spare2, spare1 }, |
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| shortDRX | SEQUENCE { |
| drx-ShortCycle | ENUMERATED { |
| | ms2, ms3, ms4, ms5, ms6, ms7, ms8, ms10, ms14, ms16, ms20, |
| | ms30, ms32, ms35, ms40, ms64, ms80, ms128, ms160, ms256, |
| | ms320, ms512, ms640, spare9, spare8, spare7, spare6, spare5, |
| | spare4, spare3, spare2, spare1 }, |
| drx-ShortCycleTimer | INTEGER (1..16) OPTIONAL, -- Need R |
| drx-SlotOffset | INTEGER (0..31) |

}
-- TAG-DRX-CONFIG-STOP
-- ASN1STOP

If the Short cycle is configured, the value of drx-LongCycle is a multiple of the drx-ShortCycle value.

If the UE uses the Long DRX cycle, it monitors the DL by starting the drx-onDurationTimer after drx-SlotOffset from the beginning of the subframe, if the following condition is fulfilled:

$$[ ( SFN \times 10 ) + subframe number ] modulo ( drx - LongCycle ) = drx - StartOffset ,$$

where SFN is the system frame number.

If the UE uses the Short DRX cycle, it monitors the DL by starting the drx-onDurationTimer after drx-SlotOffset from the beginning of the subframe, if the following condition is fulfilled:

$$[ ( SFN \times 10 ) + subframe number ] modulo ( drx - ShortCycle ) = ( drx - StartOffset ) modulo ( drx - ShortCycle ) .$$

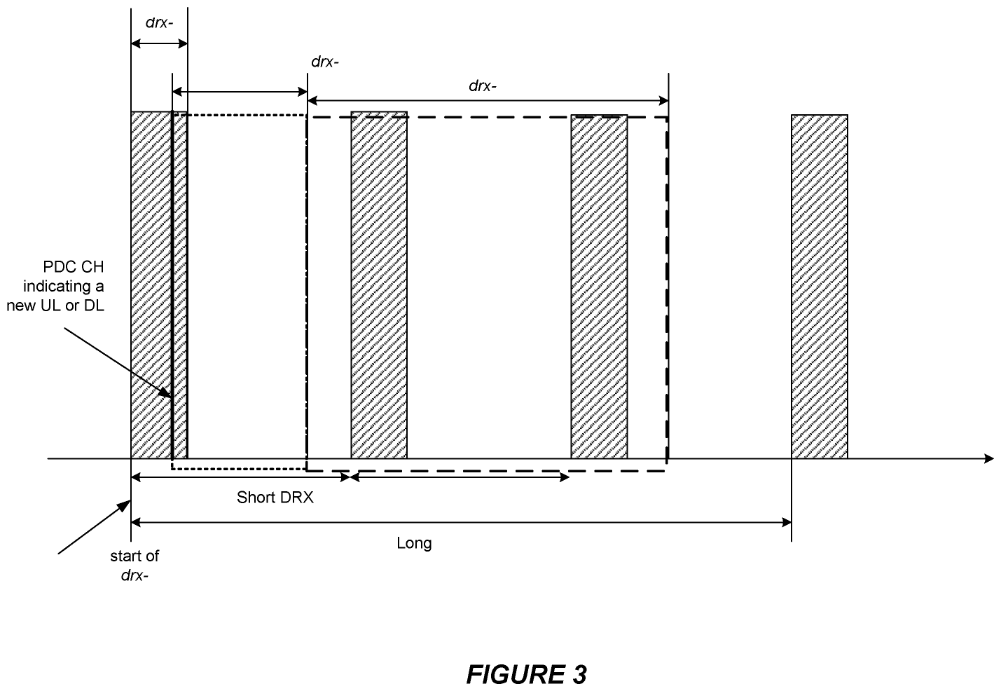

The UE DL monitoring operation according to the Long and the Short DRX cycles is illustrated in FIG. 3. In particular, FIG. 3 illustrates basic UE DL monitoring when the Long and Short DRX cycles are configured. The time during which the drx-onDurationTimer or drx-InactivityTimer is running is part of the Active Time when the UE monitors the DL.

### (1) Long DRX (Optional Short DRX not Configured)

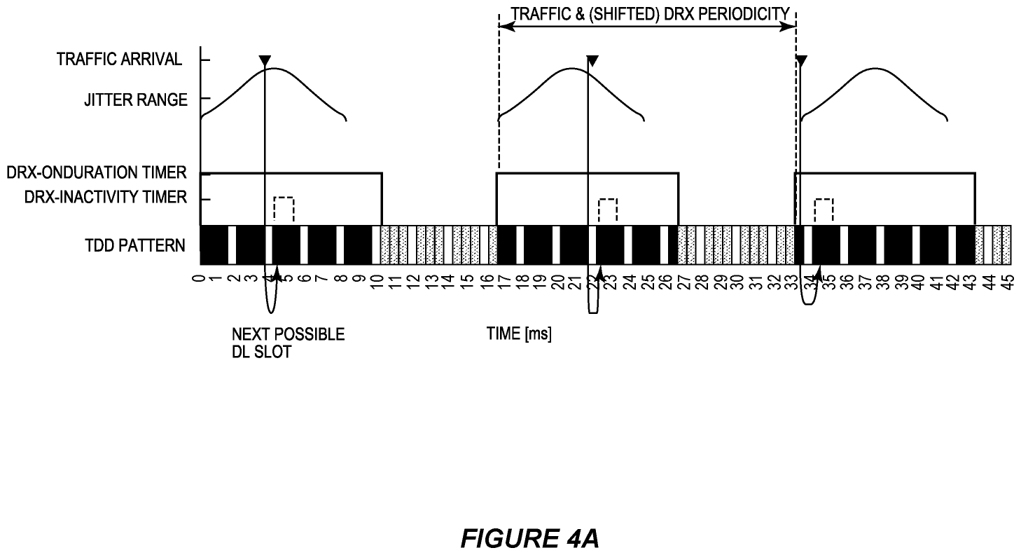

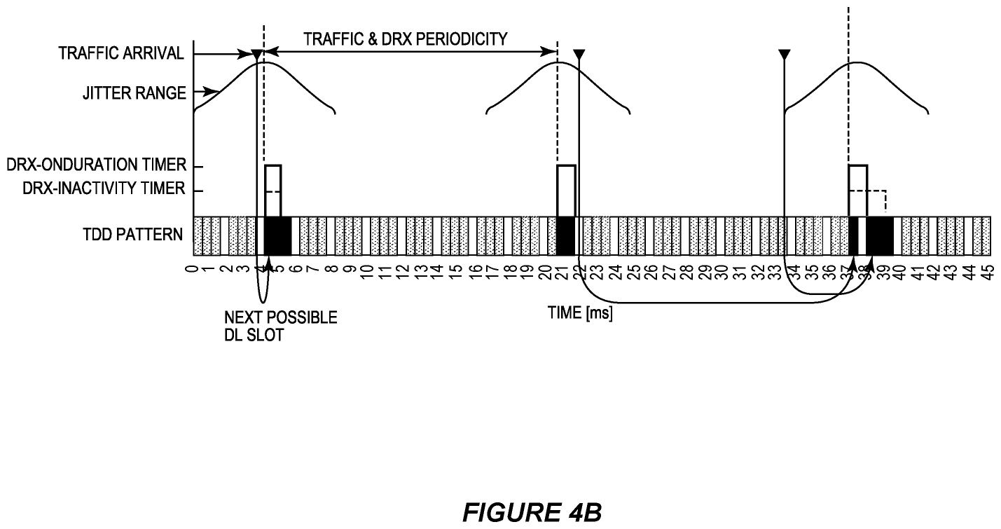

If the goal is to achieve a short data delay as typically required by XR applications, the DRX at the UE should be configured with a long drx-onDurationTimer, so that the UE is awake during the entire possible jitter range and thus the data traffic can be sent from the network to the UE immediately. However, a long drx-onDurationTimer means that the UE power consumption is high. An example illustration of such a configuration is shown in FIG. 4A, with drx-onDurationTimer=10 ms.

Conversely, if the goal is to achieve a low UE power consumption, the drx-onDurationTimer should be set to a low value, but this increases the probability that the traffic arrives either before or after the on-time of the UE, so it has to be buffered at the network until the next on-time, which increases the delay. This is illustrated in FIG. 4B, with drx-onDurationTimer=1 ms.

In particular, FIGS. 4A-4B illustrate DL traffic arrival and DL time slots for which the UE is awake (black), for Long DRX with two configurations: (A) a long drx-onDurationTimer of 10 ms and (B) a short drx-onDurationTimer of 1 ms. In this example, the traffic periodicity is 16.67 ms ( 1/60 fps), the jitter range is [−4; +4] ms, and the DRX periodicity is equal to the traffic periodicity. The time division duplexing (TDD) pattern comprises three DL slots (patterned) and one UL slot (white). The drx-InactivityTimer is 1 ms and the duration of a time slot is 0.5 ms.

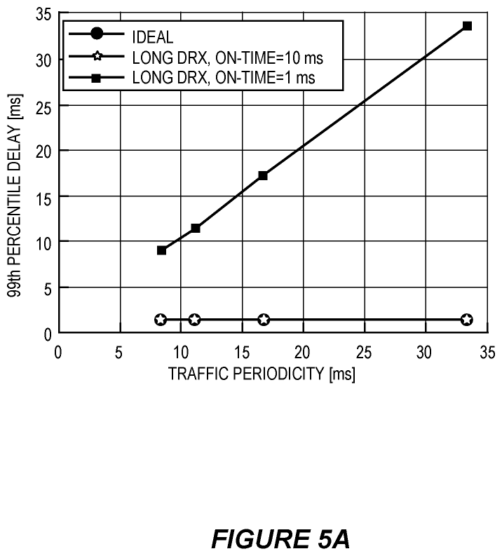

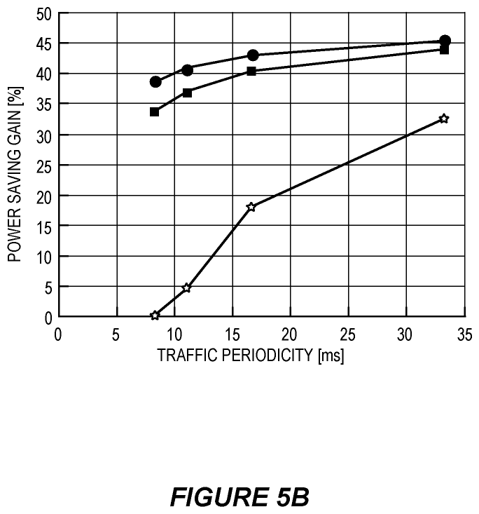

FIGS. 5A-5B respectively show the 99^{th} percentile traffic delay and power saving gain at the UE, for the two Long DRX configurations, namely drx-onDurationTimer=10 ms and 1 ms. This is shown for four video traffic periodicities (8.33, 11.11, 16.67, and 33.33 ms). The DRX periodicity is equal to that of the traffic. The power saving gain is estimated relative to the UE power consumption for the “always-on” case, where the UE is awake all the time and does not go to sleep based on DRX. Furthermore, assume the “ideal” case where the UE is awake only in the DL time slots where data is transmitted. The delay for DRX with a 10-ms on-time is short and equal to the ideal one (1.5 ms), but the power saving gains are low (down to 0%), especially for frequent traffic with low periodicities. The opposite is observed for DRX with a 1-ms on-time, where the delay is overall long (>9 ms) compared to the required PDB values for XR, but the power saving gain is high (>33%) and close to the ideal one. These results show that there is a tradeoff between the data delay and power saving gain, when configuring the drx-onDurationTimer, so a short delay and high power saving gain cannot heretofore be achieved at the same time.

### (2) Optional Short DRX Configured

The Short DRX could in principle be configured to introduce more frequent and short on-time intervals during the traffic jitter range. However, the Rel-16 Short DRX has the following important limitations.

The Short DRX cannot be activated at all if the Long DRX periodicity is a non-integer value (as may be the case if the Long DRX is matched to the traffic periodicity). This is due to the condition that the Long DRX periodicity must be a multiple of the Short DRX periodicity.

The Short DRX cycle and the Long DRX cycle cannot be started or be running at the same time. This is because there is a single drx-onDurationTimer at the UE, that is associated to either the Long or the Short cycles.

The Short DRX cycles are triggered by either a DRX Command MAC CE, or the expiration of the drx-InactivityTimer. This means that the UE cannot enter the Short DRX cycles in an efficient and flexible way. If a DRX Command MAC CE has to be sent, this consumes additional spectrum resources and introduces additional delay. If the UE has to wait for the expiration of the drx-Inactivity Timer to enter the Short DRX cycles, this may again introduce delays and a PDCCH for a new transmission has to be sent to the UE in the first place. (Note that the drx-Inactivity Timer is triggered by PDCCH reception scheduling a new transmission.)

The UE keeps entering the Short DRX cycles every time that the drx-Inactivity Timer expires, even if the Short DRX cycles may not be needed anymore. This may introduce additional unnecessary on-time and thus an unnecessary UE power consumption.

The Short DRX cycles are stopped by the expiration of the drx-ShortCycle Timer or the reception of a Long DRX Command MAC CE. This may not be fast enough to interrupt the Short cycles when they are not needed anymore, so the UE could waste energy.

Certain aspects of the disclosure and their embodiments may provide solutions to these or other challenges. Some embodiments provide a new type of DRX mechanism for the UE, which comprises an “Outer” and an “Inner” DRX cycle. Generally, the Outer DRX cycle determines when the Inner DRX cycle is running. The Inner DRX cycle determines when the UE is awake. Thus, frequent and short awake periods of time can be achieved over a given traffic jitter range that is repeated periodically (i.e., for traffic that is periodic, but has jitter around the main periodicity). The new Inner/Outer DRX mechanism achieves both a short data delay and low UE power consumption.

Some embodiments thereby propose a new type of DRX mechanism at the UE side, with two nested DRX cycles, namely Outer and Inner. The Outer cycle determines when the Inner cycle is active. The Inner cycle determines when the UE is active.

Certain embodiments may provide one or more of the following technical advantage(s). One advantage is that the proposed new Inner/Outer DRX mechanism can cover the entire range of traffic jitter with frequent periodicities and short on-time durations. Consequently, the traffic delay is kept short, and the UE power consumption is reduced compared to a long on-time covering the same jitter range, as in the legacy Long DRX solution. Another advantage is that the new Inner DRX cycles can be stopped immediately after receiving the periodic data (and until the next data period), so additional power can be saved at the UE.

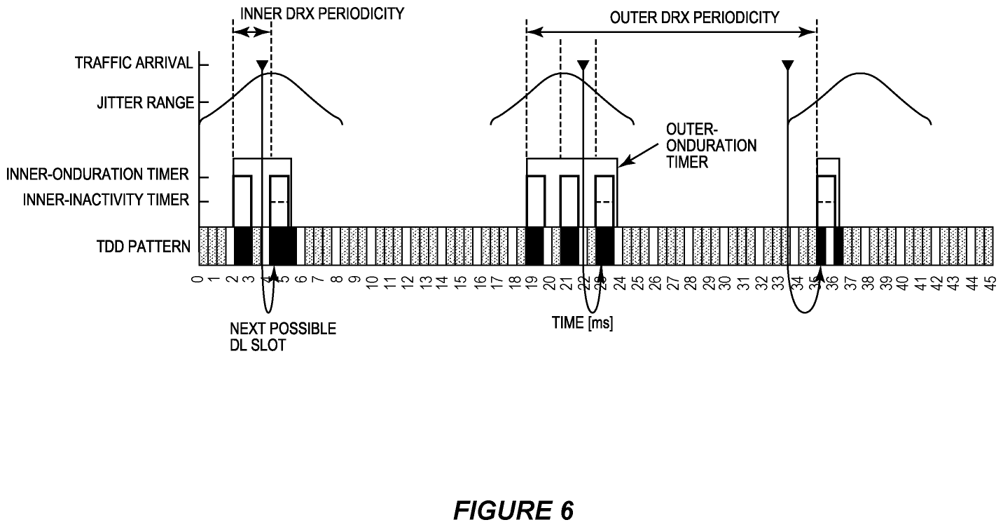

The resulting impact of the proposed Inner/Outer DRX on the number of time slots where the UE is awake is illustrated in FIG. 6. In particular, FIG. 6 illustrates DL traffic arrival and DL time slots for which the UE is awake (black), for the proposed Inner/Outer DRX, for Inner-onDurationTimer=1 ms. In this example, the traffic periodicity is 16.67 ms ( 1/60 fps), the jitter range is [−4; +4] ms, the Outer DRX periodicity is equal to the traffic periodicity, and the Inner DRX periodicity is 2 ms. The TDD pattern comprises three DL slots (patterned) and one UL slot (white). The Inner-Inactivity Timer is 1 ms and the duration of a time slot is 0.5 ms. The Outer-onDurationTimer is terminated after data transmission.

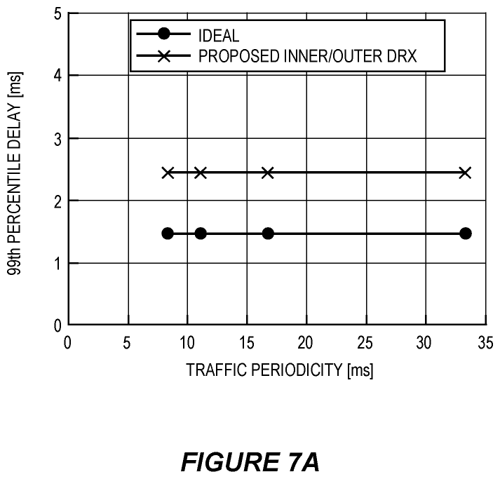

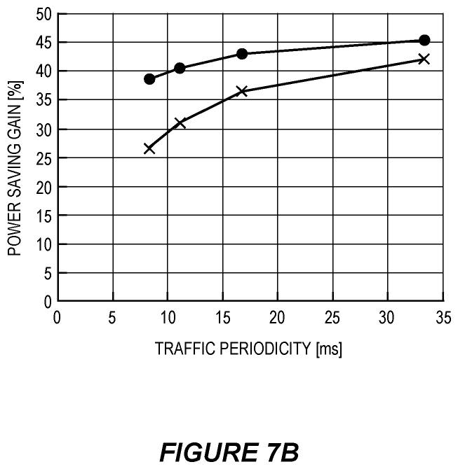

FIGS. 7A-7B respectively show the delay and UE power saving gain, e.g., as compared to FIGS. 5A-5B. The delay is low (2.5 ms) and only marginally higher than the ideal delay (1.5 ms), for all traffic periodicities. Furthermore, the power saving gain ranges from 26% to 42% and is only 3-13 percent points (pp) lower than the ideal saving gain. Consequently, the proposed Inner/Outer DRX achieves a very good balance between delay and power saving gain.

Note that Inner-onDuration is defined as the period of time in which the Inner-onDurationTimer is running. Outer-onDuration is defined as the period of time in which the Outer-onDurationTimer is running.

Note, too, that Inner-onDurationTimer may exemplify the inner on-duration timer 15A herein whereas the Outer-onDurationTimer may exemplify the outer on-duration timer 15B herein.

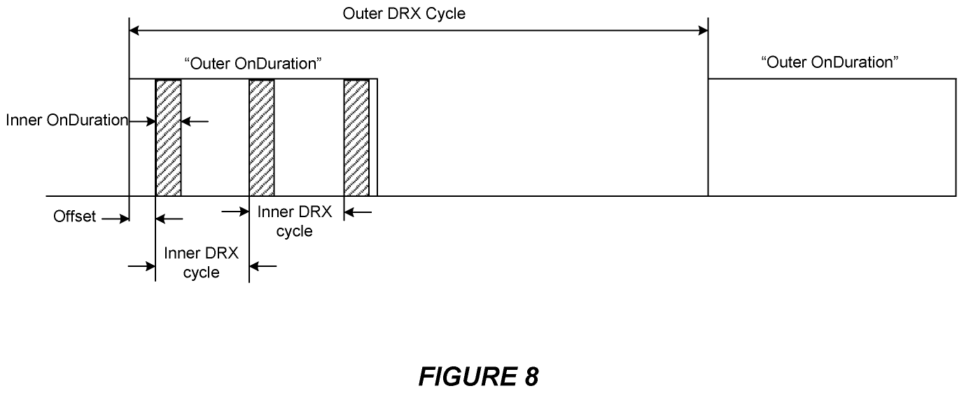

Broadly, some embodiments herein have an Inner DRX cycle within an Outer DRX cycle. Inner DRX cycle could be understood as a legacy Short DRX cycle while Outer DRX cycle could be understood as a Long DRX cycle, except that the Short DRX cycle is allowed to overlap in time with the Outer DRX cycle. The Outer DRX cycle defines the time/slots in which the Inner DRX cycle is executed and the other time/slots in which the Inner DRX cycle is not executed. The period in which the Inner DRX cycle is executed is limited by the “Outer-onDurationTimer”. The “Outer OnDuration Timer” may correspond to the on-duration parameter/timer defined for the Long DRX Cycle, with the difference that, during the on-duration in the Long DRX Cycle, the UE monitors the Physical Downlink Control Channel (PDCCH). In some embodiments, the UE does not continuously monitor the PDCCH while the Outer-onDurationTimer is running. The UE will, however, monitor the PDCCH according to the Inner DRX cycle configuration, i.e., while the “Inner-onDurationTimer” is running or while the “Inner-InactivityTimer” is running. FIG. 8 illustrates the concept of Outer and Inner DRX cycle according to some embodiments. In that illustration, the “Inner-onDurationTimer” is (re-) started three times, with the start offset of the first Inner-OnDuration inside of Outer-OnDuration. Outside of Outer-OnDuration, there are no Inner-OnDurations defined to further monitor PDCCHs, since the network expects there are no new burst arrivals of traffic.

While Inner-onDurationTimer is running, a PDCCH reception will start or re-start the Inner-InactivityTimer, as in the legacy Short DRX, to allow continuous monitoring of the next PDCCH transmissions. On the other hand, a PDCCH reception would not have any impact on the Outer DRX cycle. As a non-limiting example, Outer-OnDuration can be extended or shortened by a purpose based on MAC CE or radio resource control (RRC) signaling, in order to further save UE power when a network foresees less or more jitter in traffic arrival.

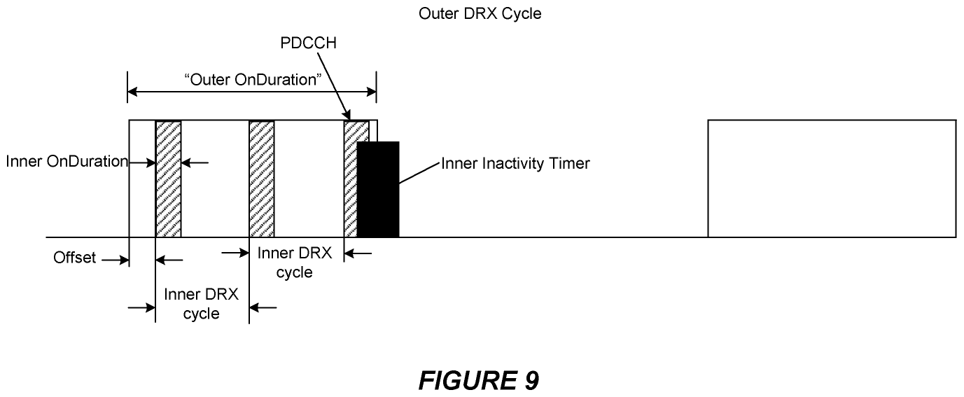

When the Outer-onDurationTimer expires, all timers running by the Inner DRX cycle are stopped and the UE will not monitor PDCCH until the next Outer-OnDuration. Alternatively, the UE returns to the non-PDCCH monitoring period once the Outer-onDurationTimer expires and, the current Inner-onDurationTimer and the Inner-InactivityTimer expire or are stopped, as shown in FIG. 9. FIG. 9 in particular illustrates Inner/Outer DRX when the Outer-onDurationTimer expires, but the Inner-InactivityTimer is still running.

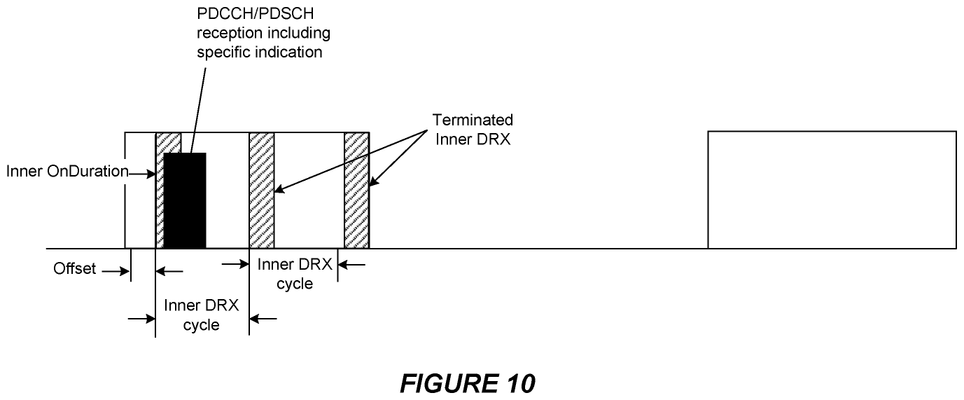

Additionally, the Outer-onDurationTimer and/or Inner-onDurationTimer and/or Inner-Inactivity Timer can be terminated in one or more Outer DRX cycles, if the network sends to the UE a specific indication, as shown in FIG. 10. This will be useful when there are no more expected traffic arrivals after the first few Inner DRX cycles, so that Inner-onDurationTimer is not re-started to save UE power. This indication can be in Physical Downlink Shared Channel (PDSCH), e.g., indication in a MAC subheader or a separate MAC CE command. Alternatively, the indication can be sent in Downlink Control Information (DCI) with PDCCH. The indication, regardless of whether it is sent on PDCCH or PDSCH, can include one or more Inner DRX cycles in the corresponding Outer DRX cycle, or N following Outer DRX cycles. The number of Inner DRX cycles to be terminated can be also included in MAC CE, MAC header, or DCI.

### Inner/Outer DRX Operation Details

This section explains the ideas above in greater detail, i.e. (2)a)-b) and (3)c), and presents additional flow charts. In some embodiments, a UE configured with Inner/Outer DRX performs the following.

(1) The UE starts the Outer-onDurationTimer when the offset and periodicity conditions of the Outer DRX cycle are fulfilled. These conditions can be verified based on a formula, e.g., as for the Long DRX in 3GPP Rel-16.

(2) Additionally, the UE starts the Inner-onDurationTimer if the Outer-onDurationTimer is running and if the offset and periodicity conditions of the Inner DRX cycle are fulfilled, with respect to the start of the Outer DRX cycle.

(2a) To verify the offset and periodicity conditions to start the Inner-onDurationTimer, a formula can be used in some embodiments. This formula should make the start of the Inner-onDurationTimer dependent on the start of the Outer-onDurationTimer in which in the Inner DRX cycle resides. Such a formula is:

$$[ SFN \times 10 + subframe number - OuterDrxOffset ] mod ( InnerDrxCycle ) = InnerDrxOffset .$$

SFN is the system frame number, where each frame contains 10 subframes, so that SFN×10+subframe number is a unique identifier for each subframe. The term OuterDrxOffset is the identifier of the subframe where the current Outer DRX cycle started, InnerDrxCycle is the periodicity of the DRX Inner cycle, and InnerDrxOffset is the offset (in number of subframes) of the first Inner-onDurationTimer with respect to the start of the Outer-onDurationTimer, as shown in FIG. 8.

(2b) Alternatively to (2a), the UE can keep a counter/timer that is (re-) started when the Outer-onDurationTimer is started. The condition to start the Inner-onDurationTimer is fulfilled when

$$counter = InnerDrxOffset + n \times InnerDrxCycle ,$$

$$where n is an integer with values \{ 0 , 1 , 2 , … \} .$$

(3) During the time that the Inner-onDurationTimer or Inner-Inactivity Timer is running, the UE monitors the PDCCH. If a PDCCH is received and indicates a new transmission, the Inner-InactivityTimer is started/restarted. Three different options to stop the timers follow as (3a)-(3c).

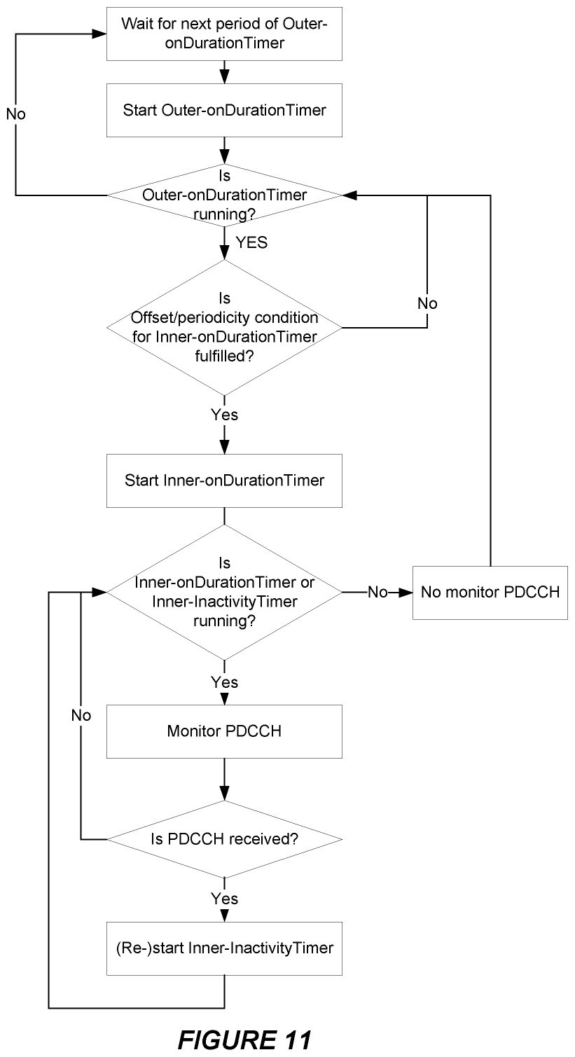

(3a) After both the Inner-onDurationTimer and the Inner-InactivityTimer have expired, the UE stops monitoring the PDCCH and checks the Outer-onDurationTimer. If and while the Outer-onDurationTimer is still running, the UE waits for the next periodicity condition to start the Inner-onDurationTimer again and repeat PDCCH monitoring. If and when the Outer-onDurationTimer has expired, the UE waits to meet the condition to start again the Outer-onDurationTimer. This behaviour is shown in FIG. 11.

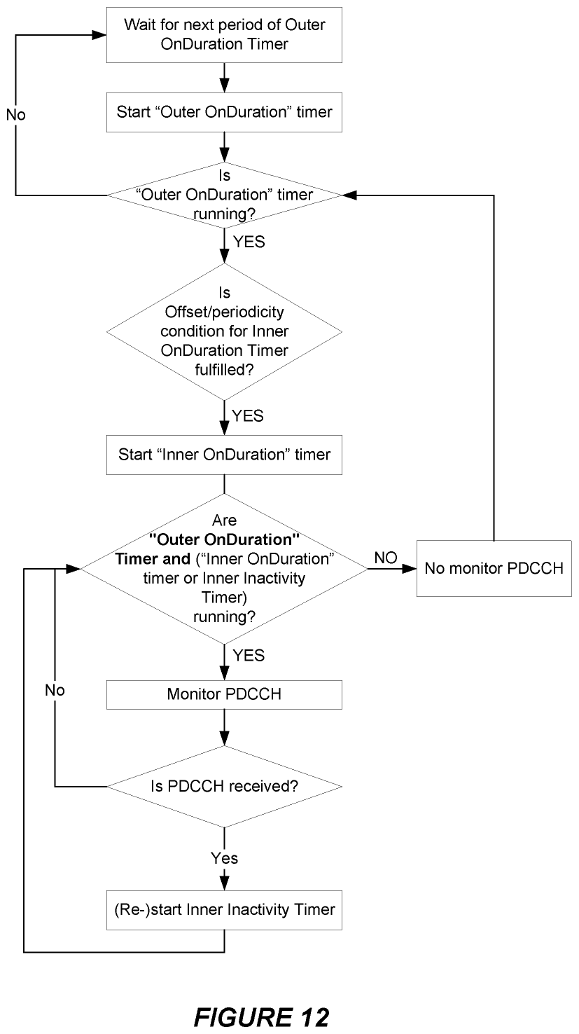

(3b) Alternatively to (3a), the UE keeps checking if the Outer-onDurationTimer is running at the same time with Inner-onDurationTimer or the Inner-Inactivity Timer. If and when the Outer-onDurationTimer expires, the UE stops the Inner-onDurationTimer and the Inner-InactivityTimer. The UE then waits for the next Outer-onDurationTimer start condition to be fulfilled. This is shown in FIG. 12.

(3c) In addition to (3a) or (3b), the Outer-onDurationTimer, Inner-onDurationTimer, and Inner-Inactivity Timer can be stopped upon reception of a network indication. The indication could affect one or more of the following timers: Outer-OnDurationTimer, Inner-OnDurationTimer, and Inner-Inactivity Timer.

(3c) (i) A downlink control information (DCI) message in PDCCH. Both UL and DL DCI formats can be used for fast indication of skipping the next one or more Inner-onDuration(s) as long as current Outer-onDurationTimer is running. It could also indicate the termination/stop of the (1) current Outer-OnDurationTimer, (2) Inner-OnDurationTimer and Inner-InactivityTimer, or (3) all three timers, the Outer-OnDurationTimer, Inner-OnDurationTimer, and Inner-InactivityTimer. Upon this indication and, depending which timer(s) are stopped, the procedure would follow the process outlined in (3a) or (3b).

(3c) (ii) a MAC Control Element (CE) command in PDSCH. The MAC CE can be a special command identified by a specific Logical Channel ID (LCID). Upon reception of the specific MAC CE while Outer-onDurationTimer is running, the UE would stop the (1) current Outer-OnDurationTimer, (2) Inner-OnDurationTimer and Inner-InactivityTimer, or (3) all three timers, the Outer-OnDurationTimer, Inner-OnDurationTimer, and Inner-InactivityTimer. Upon this indication and, depending which timer(s) are stopped, the procedure would follow the process outlined in (3a) or (3b). Additionally, the MAC CE could include timing information pointing at the time the corresponding timer(s) should be stopped.

(3c) (iii) a MAC subheader in PDSCH. Similarly as in (3c) (ii), a MAC subheader could carry an indication which would result in that the UE would stop one or more of the timers.

### Inner/Outer DRX Configuration

A UE supporting such a feature would report to the network its support. The network can then configure the UE via RRC to use this feature. In case it is possible to configure multiple DRX configurations, this indication may also be provided for each of the DRX configurations provided to the UE. The network may configure such a feature, for instance, to be used with video traffic which has certain jitter, but might not configure the feature to other types of traffic such as pose traffic or eMBB. Other types of traffic could be configured with the legacy DRX configurations.

### Flexible Inner DRX Configuration

In some embodiments, the Inner-OnDuration in each Inner DRX cycle can be separately configured, which can be useful when the probability of traffic arrival in the Outer-OnDuration is not uniform. When there are N different Inner-OnDuration whose length is denoted by d_1 to d_n, d_1 to d_n can be separately configured by RRC or MAC CE signaling and they can be repeated in every Outer-OnDuration.

In other embodiments, a network can define X different types of Inner-OnDuration, which are fewer than or equal to N and assign each Inner-OnDuration with a certain type. For example, when most of the traffic is expected in the middle of Outer-OnDuration, a network can signal a long Inner-OnDuration for Inner DRX cycles which are configured to start within a certain range from the mid-point timing of the corresponding Outer-OnDuration. For the other Inner DRX cycles which are out of the range from the mid-point, a shorter Inner-OnDuration type is indicated by a network.

Similarly, in some embodiments, intervals between Inner-OnDurations can be differentiated in a given Outer DRX cycle to allow more dense Inner DRX cycles in a certain range close to the mid-point of Outer-OnDuration, so that a UE can more frequently monitor PDCCHs in the center of Outer-OnDuration than the edge of Outer-OnDuration, when more traffic arrives in the middle of Outer-OnDuration. The intervals can be preconfigured by RRC or MAC CE signal and can be repeated in every Outer DRX cycle.

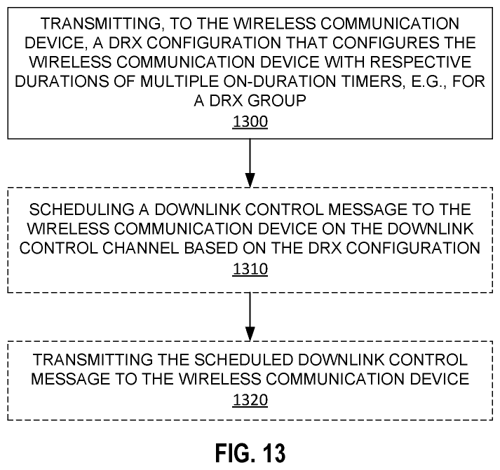

In view of the modifications and variations herein, FIG. 13 depicts a method performed by a network node 12 of configuring a wireless communication device 14 for discontinuous reception, DRX, operation in a wireless communication network 10. The method comprises transmitting, to the wireless communication device 14, a DRX configuration 26 that configures the wireless communication device 14 with respective durations 28 of multiple on-duration timers 15, e.g., for a DRX group (Block 1300). In some embodiments, where the multiple on-duration timers 15 are timers for a DRX group, the DRX group comprises one or more serving cells of the wireless communication device 14.

In some embodiments, the multiple on-duration timers govern an active time, for the DRX group, during which the wireless communication device is to monitor a downlink control channel on the one or more serving cells. In one or more of these embodiments, the active time for the DRX group includes at least time while the multiple on-duration timers are running simultaneously. In one or more of these embodiments, the active time for the DRX group includes time while the multiple on-duration timers are running. In one or more of these embodiments, the multiple on-duration timers include an inner on-duration timer and an outer on-duration timer. In this case, the active time for the DRX group includes at least time while the inner on-duration timer is running. In one or more of these embodiments, running of the outer on-duration timer is a prerequisite for starting or re-starting the inner on-duration timer. In one or more of these embodiments, stopping or expiry of the outer on-duration timer triggers prohibiting starting or re-starting the inner on-duration timer and starting or re-starting of the outer on-duration timer triggers allowing starting or re-starting the inner on-duration timer. In one or more of these embodiments, stopping or expiry of the outer on-duration timer triggers stopping of the inner on-duration timer. In one or more of these embodiments, stopping or expiry of the outer on-duration timer triggers stopping of an inactivity timer. In this case, the active time for the DRX group also includes at least time while the inactivity timer is running. In one or more of these embodiments, the method further comprises transmitting, to the wireless communication device, a stop indication that indicates the wireless communication device is to stop one or more of the inner on-duration timer, the outer on-duration timer, and an inactivity timer.

In some embodiments, the multiple on-duration timers include an inner on-duration timer and an outer on-duration timer. In one or more of these embodiments, while the outer on-duration timer is running, the wireless communication device is to monitor a downlink control channel on the one or more serving cells discontinuously at times when the inner on-duration timer runs. In one or more of these embodiments, the duration of the inner on-duration timer is shorter than the duration of the outer on-duration timer. In one or more of these embodiments, an on-duration period of an inner DRX cycle has a duration equal to the duration of the inner on-duration timer. In this case, an on-duration period of an outer DRX cycle has a duration equal to the duration of the outer on-duration timer, and the on-duration period of an outer DRX cycle spans a set of multiple inner DRX cycles. In one or more of these embodiments, the DRX configuration configures different durations of the inner on-duration timer for at least some inner DRX cycles in the set. In one or more of these embodiments, the DRX configuration configures at least some of the inner DRX cycles in the set to have different durations. In one or more of these embodiments, the outer on-duration timer is to be started if one or more outer conditions are each fulfilled, and the inner on-duration timer is to be started if one or more inner conditions are each fulfilled, wherein the one or more inner conditions include a condition that the outer on-duration timer is running.

In some embodiments, the multiple on-duration timers include multiple inner on-duration timers and also include an outer on-duration timer. In this case, an on-duration period of an outer DRX cycle has a duration equal to the duration of the outer on-duration timer, an on-duration period of an outer DRX cycle spans a set of multiple inner DRX cycles, and the on-duration periods of at least some of the multiple inner DRX cycles in the set have different durations corresponding to the durations of the multiple inner on-duration timers.

In some embodiments, the multiple on-duration timers include an inner on-duration timer and an outer on-duration timer. In this case, the active time further depends on an inactivity timer, and the active time for the DRX group includes at least time while the inner and outer on-duration timers are running simultaneously, and time while the outer on-duration timer and the inactivity timer are running simultaneously.

In some embodiments, the DRX configuration is specific to a certain type of service or traffic. In one or more of these embodiments, the certain type of service is an extended Reality, XR, service.

In some embodiments, the method also comprises scheduling a downlink control message to the wireless communication device 14 on a downlink control channel 18 based on the DRX configuration 26 (Block 1310) and transmitting the scheduled downlink control message to the wireless communication device 14 (Block 1320).

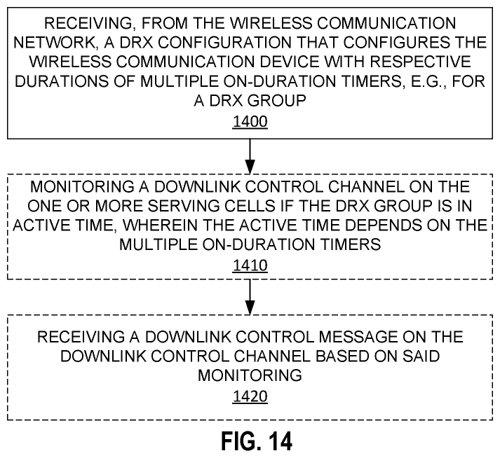

FIG. 14 depicts a method performed by a wireless communication device 14 for discontinuous reception, DRX, operation in a wireless communication network 10 in accordance with particular embodiments. The method includes receiving, from the wireless communication network 10, a DRX configuration 26 that configures the wireless communication device 14 with respective durations 28 of multiple on-duration timers 15, e.g., for a DRX group (Block 1400). In some embodiments, where the multiple on-duration timers 15 are timers for a DRX group, the DRX group comprises one or more serving cells of the wireless communication device 14.

In some embodiments, the method also comprises monitoring a downlink control channel 18 on the one or more serving cells if the DRX group is in active time 20, wherein the active time 20 depends on the multiple on-duration timers 15 (Block 1410). In one or more of these embodiments, the active time for the DRX group includes at least time while the multiple on-duration timers are running simultaneously. In one or more of these embodiments, the active time for the DRX group includes time while the multiple on-duration timers are running. In one or more of these embodiments, the multiple on-duration timers include an inner on-duration timer and an outer on-duration timer, and the active time for the DRX group includes at least time while the inner on-duration timer is running. In one or more of these embodiments, running of the outer on-duration timer is a prerequisite for starting or re-starting the inner on-duration timer. In one or more of these embodiments, stopping or expiry of the outer on-duration timer triggers prohibiting starting or re-starting the inner on-duration timer and starting or re-starting of the outer on-duration timer triggers allowing starting or re-starting the inner on-duration timer. In one or more of these embodiments, stopping or expiry of the outer on-duration timer triggers stopping of the inner on-duration timer. In one or more of these embodiments, stopping or expiry of the outer on-duration timer triggers stopping of an inactivity timer, and the active time for the DRX group also includes at least time while the inactivity timer is running. In one or more of these embodiments, receipt by the wireless communication device of a stop indication from the wireless communication network triggers stopping of one or more of the inner on-duration timer, the outer on-duration timer, and an inactivity timer.

In some embodiments, the multiple on-duration timers include an inner on-duration timer and an outer on-duration timer. In one or more of these embodiments, the method further comprises, while the outer on-duration timer is running, monitoring a downlink control channel on the one or more serving cells discontinuously at times when the inner on-duration timer runs. In one or more of these embodiments, the duration of the inner on-duration timer is shorter than the duration of the outer on-duration timer. In one or more of these embodiments, an on-duration period of an inner DRX cycle has a duration equal to the duration of the inner on-duration timer, an on-duration period of an outer DRX cycle has a duration equal to the duration of the outer on-duration timer, and the on-duration period of an outer DRX cycle spans a set of multiple inner DRX cycles. In one or more of these embodiments, the DRX configuration configures different durations of the inner on-duration timer for at least some inner DRX cycles in the set. In one or more of these embodiments, the DRX configuration configures at least some of the inner DRX cycles in the set to have different durations. In one or more of these embodiments, the method further comprises starting the outer on-duration timer if one or more outer conditions are each fulfilled, and starting the inner on-duration timer if one or more inner conditions are each fulfilled. In this case, the one or more inner conditions include a condition that the outer on-duration timer is running.

In some embodiments, the multiple on-duration timers include multiple inner on-duration timers and also include an outer on-duration timer. In this case, an on-duration period of an outer DRX cycle has a duration equal to the duration of the outer on-duration timer, an on-duration period of an outer DRX cycle spans a set of multiple inner DRX cycles, and on-duration periods of at least some of the multiple inner DRX cycles in the set have different durations corresponding to the durations of the multiple inner on-duration timers.

In some embodiments, the multiple on-duration timers include an inner on-duration timer and an outer on-duration timer. In this case, the active time further depends on an inactivity timer, and the active time for the DRX group includes at least time while the inner and outer on-duration timers are running simultaneously, and time while the outer on-duration timer and the inactivity timer are running simultaneously.

In some embodiments, the DRX configuration is specific to a certain type of service or traffic. In one or more of these embodiments, the certain type of service is an extended Reality, XR, service.

In some embodiments, the method further comprises receiving a downlink control message on the downlink control channel 18 based on said monitoring (Block 1420).

Embodiments herein also include corresponding apparatuses. Embodiments herein for instance include a wireless communication device 14 configured to perform any of the steps of any of the embodiments described above for the wireless communication device 14.

Embodiments also include a wireless communication device 14 comprising processing circuitry and power supply circuitry. The processing circuitry is configured to perform any of the steps of any of the embodiments described above for the wireless communication device 14. The power supply circuitry is configured to supply power to the wireless communication device 14.

Embodiments further include a wireless communication device 14 comprising processing circuitry. The processing circuitry is configured to perform any of the steps of any of the embodiments described above for the wireless communication device 14. In some embodiments, the wireless communication device 14 further comprises communication circuitry.

Embodiments further include a wireless communication device 14 comprising processing circuitry and memory. The memory contains instructions executable by the processing circuitry whereby the wireless communication device 14 is configured to perform any of the steps of any of the embodiments described above for the wireless communication device 14.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless communication device 14. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 12 configured to perform any of the steps of any of the embodiments described above for the network node 12.

Embodiments also include a network node 12 comprising processing circuitry and power supply circuitry. The processing circuitry is configured to perform any of the steps of any of the embodiments described above for the network node 12. The power supply circuitry is configured to supply power to the network node 12.

Embodiments further include a network node 12 comprising processing circuitry. The processing circuitry is configured to perform any of the steps of any of the embodiments described above for the network node 12. In some embodiments, the network node 12 further comprises communication circuitry.

Embodiments further include a network node 12 comprising processing circuitry and memory. The memory contains instructions executable by the processing circuitry whereby the network node 12 is configured to perform any of the steps of any of the embodiments described above for the network node 12.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

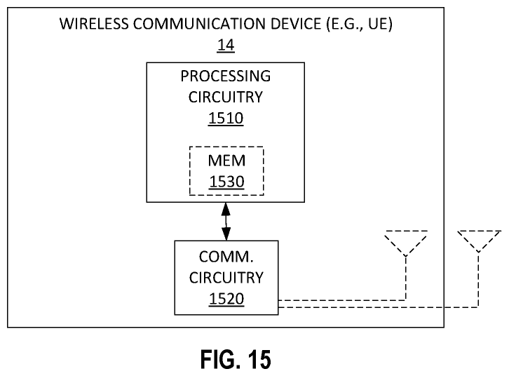

FIG. 15 for example illustrates a wireless communication device 14 as implemented in accordance with one or more embodiments. As shown, the wireless communication device 14 includes processing circuitry 1510 and communication circuitry 1520. The communication circuitry 1520 (e.g., radio circuitry) is configured to transmit and/or receive information to and/or from one or more other nodes, e.g., via any communication technology. Such communication may occur via one or more antennas that are either internal or external to the wireless communication device 1500. The processing circuitry 1510 is configured to perform processing described above, e.g., in FIG. 14, such as by executing instructions stored in memory 1530. The processing circuitry 1510 in this regard may implement certain functional means, units, or modules.

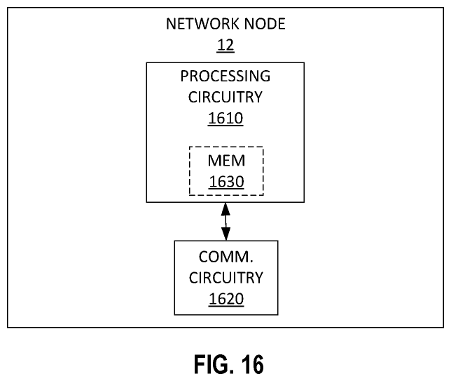

FIG. 16 illustrates a network node 14 as implemented in accordance with one or more embodiments. As shown, the network node 14 includes processing circuitry 1610 and communication circuitry 1620. The communication circuitry 1620 is configured to transmit and/or receive information to and/or from one or more other nodes, e.g., via any communication technology. The processing circuitry 1610 is configured to perform processing described above, e.g., in FIG. 13, such as by executing instructions stored in memory 1630. The processing circuitry 1610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

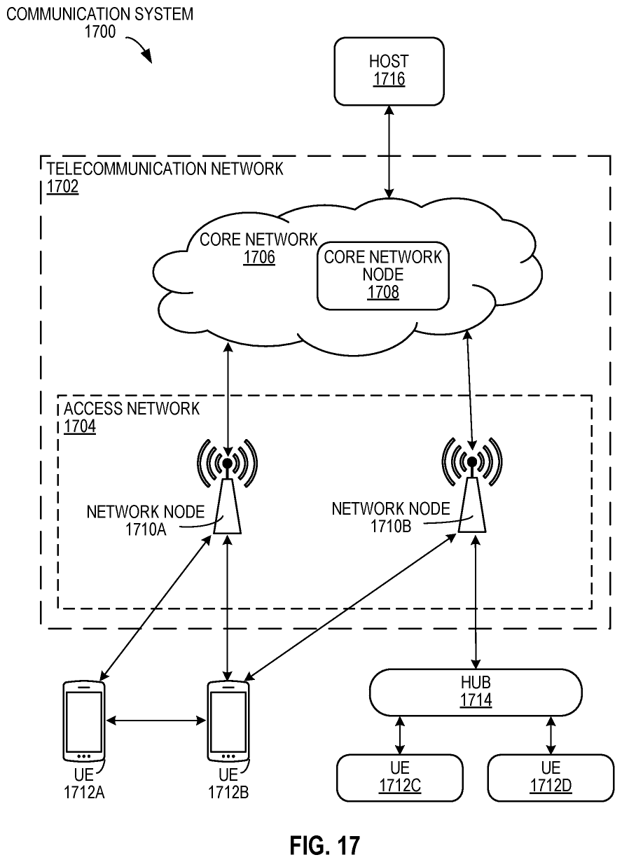

FIG. 17 shows an example of a communication system 1700 in accordance with some embodiments.

In the example, the communication system 1700 includes a telecommunication network 1702 that includes an access network 1704, such as a radio access network (RAN), and a core network 1706, which includes one or more core network nodes 1708. The access network 1704 includes one or more access network nodes, such as network nodes 1710a and 1710b (one or more of which may be generally referred to as network nodes 1710), or any other similar 3^{rd} Generation Partnership Project (3GPP) access node or non-3GPP access point. The network nodes 1710 facilitate direct or indirect connection of user equipment (UE), such as by connecting UEs 1712a, 1712b, 1712c, and 1712d (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1702 is a cellular network that implements 3GPP standardized features. Accordingly, the telecommunications network 1702 may support network slicing to provide different logical networks to different devices that are connected to the telecommunication network 1702. For example, the telecommunications network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1714 communicates with the access network 1704 to facilitate indirect communication between one or more UEs (e.g., UE 1712c and/or 1712d) and network nodes (e.g., network node 1710b). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a VR headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular in if one or more of the UEs are low energy IoT devices.

The hub 1714 may have a constant/persistent or intermittent connection to the network node 1710b. The hub 1714 may also allow for a different communication scheme and/or schedule between the hub 1714 and UEs (e.g., UE 1712c and/or 1712d), and between the hub 1714 and the core network 1706. In other examples, the hub 1714 is connected to the core network 1706 and/or one or more UEs via a wired connection. Moreover, the hub 1714 may be configured to connect to an M2M service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710b. In other embodiments, the hub 1714 may be a non-dedicated hub—that is, a device which is capable of operating to route communications between the UEs and network node 1710b, but which is additionally capable of operating as a communication start and/or end point for certain data channels.

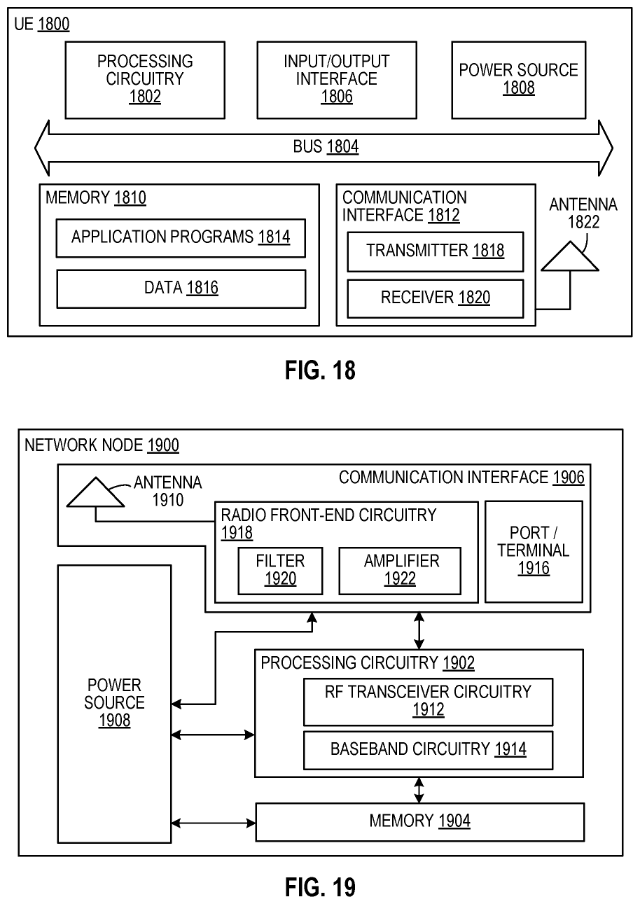

FIG. 18 shows a UE 1800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1802 may include multiple central processing units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

The memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1810 may allow the UE 1800 to access instructions, application programs and the like, stored on transitory or non-transitory memory media, to off-load data, or to upload data. An article of manufacture, such as one utilizing a communication system may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., antenna 1822) and may share circuit components, software or firmware, or alternatively be implemented separately.

In the illustrated embodiment, communication functions of the communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1900 includes a processing circuitry 1902, a memory 1904, a communication interface 1906, and a power source 1908. The network node 1900 may be composed of multiple physically separate components (e.g., a NodeB component and a RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

The processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as the memory 1904, to provide network node 1900 functionality.

In some embodiments, the processing circuitry 1902 includes a system on a chip (SOC). In some embodiments, the processing circuitry 1902 includes one or more of radio frequency (RF) transceiver circuitry 1912 and baseband processing circuitry 1914. In some embodiments, the radio frequency (RF) transceiver circuitry 1912 and the baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

The memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions capable of being executed by the processing circuitry 1902 and utilized by the network node 1900. The memory 1904 may be used to store any calculations made by the processing circuitry 1902 and/or any data received via the communication interface 1906. In some embodiments, the processing circuitry 1902 and memory 1904 is integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. Radio front-end circuitry 1918 comprises filters 1920 and amplifiers 1922. The radio front-end circuitry 1918 may be connected to an antenna 1910 and processing circuitry 1902. The radio front-end circuitry may be configured to condition signals communicated between antenna 1910 and processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of filters 1920 and/or amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface may comprise different components and/or different combinations of components.

In certain alternative embodiments, the network node 1900 does not include separate radio front-end circuitry 1918, instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes one or more ports or terminals 1916, the radio front-end circuitry 1918, and the RF transceiver circuitry 1912, as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments, the antenna 1910 is separate from the network node 1900 and connectable to the network node 1900 through an interface or port.

The antenna 1910, communication interface 1906, and/or the processing circuitry 1902 may be configured to perform any receiving operations and/or certain obtaining operations described herein as being performed by the network node. Any information, data and/or signals may be received from a UE, another network node and/or any other network equipment. Similarly, the antenna 1910, the communication interface 1906, and/or the processing circuitry 1902 may be configured to perform any transmitting operations described herein as being performed by the network node. Any information, data and/or signals may be transmitted to a UE, another network node and/or any other network equipment.

The power source 1908 provides power to the various components of network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid, an electricity outlet) via an input circuitry or interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

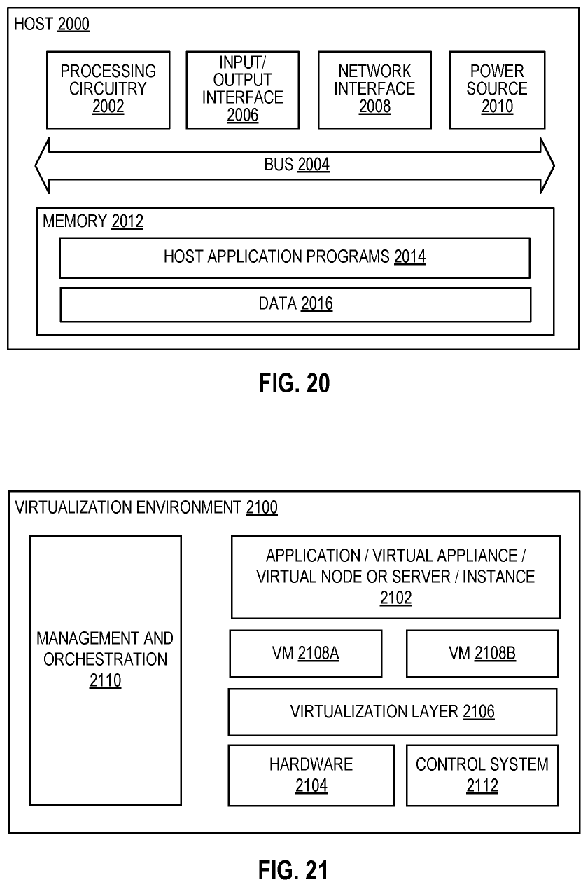

FIG. 20 is a block diagram of a host 2000, which may be an embodiment of the host 1716 of FIG. 17, in accordance with various aspects described herein. As used herein, the host 2000 may be or comprise various combinations hardware and/or software, including a standalone server, a blade server, a cloud-implemented server, a distributed server, a virtual machine, container, or processing resources in a server farm. The host 2000 may provide one or more services to one or more UEs.

The host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

The memory 2012 may include one or more computer programs including one or more host application programs 2014 and data 2016, which may include user data, e.g., data generated by a UE for the host 2000 or data generated by the host 2000 for a UE. Embodiments of the host 2000 may utilize only a subset or all of the components shown. The host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2014 may also provide for user authentication and licensing checks and may periodically report health, routes, and content availability to a central node, such as a device in or on the edge of a core network. Accordingly, the host 2000 may select and/or indicate a different host for over-the-top services for a UE. The host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a and 2108b (one or more of which may be generally referred to as VMs 2108), and/or perform any of the functions, features and/or benefits described in relation with some embodiments described herein. The virtualization layer 2106 may present a virtual operating platform that appears like networking hardware to the VMs 2108.

The VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2108 may be a software implementation of a physical machine that runs programs as if they were executing on a physical, non-virtualized machine. Each of the VMs 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

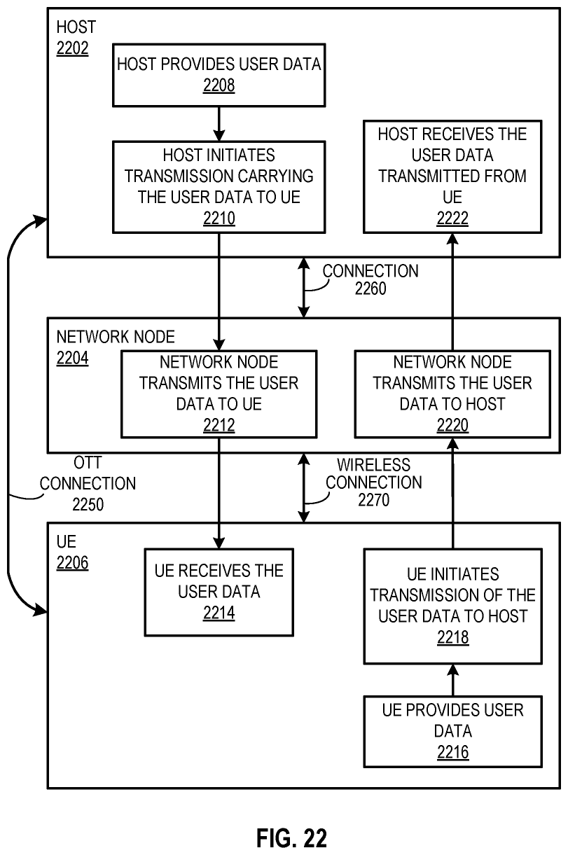

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. The host 2202 also includes software, which is stored in or accessible by the host 2202 and executable by the processing circuitry. The software includes a host application that may be operable to provide a service to a remote user, such as the UE 2206 connecting via an over-the-top (OTT) connection 2250 extending between the UE 2206 and host 2202. In providing the service to the remote user, a host application may provide user data which is transmitted using the OTT connection 2250.

The network node 2204 includes hardware enabling it to communicate with the host 2202 and UE 2206. The connection 2260 may be direct or pass through a core network (like core network 1706 of FIG. 17) and/or one or more other intermediate networks, such as one or more public, private, or hosted networks. For example, an intermediate network may be a backbone network or the Internet.

The UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of the host 2202. In the host 2202, an executing host application may communicate with the executing client application via the OTT connection 2250 terminating at the UE 2206 and host 2202. In providing the service to the user, the UE's client application may receive request data from the host's host application and provide user data in response to the request data. The OTT connection 2250 may transfer both the request data and the user data. The UE's client application may interact with the user to generate the user data that it provides to the host application through the OTT connection 2250.

The OTT connection 2250 may extend via a connection 2260 between the host 2202 and the network node 2204 and via a wireless connection 2270 between the network node 2204 and the UE 2206 to provide the connection between the host 2202 and the UE 2206. The connection 2260 and wireless connection 2270, over which the OTT connection 2250 may be provided, have been drawn abstractly to illustrate the communication between the host 2202 and the UE 2206 via the network node 2204, without explicit reference to any intermediary devices and the precise routing of messages via these devices.

As an example of transmitting data via the OTT connection 2250, in step 2208, the host 2202 provides user data, which may be performed by executing a host application. In some embodiments, the user data is associated with a particular human user interacting with the UE 2206. In other embodiments, the user data is associated with a UE 2206 that shares data with the host 2202 without explicit human interaction. In step 2210, the host 2202 initiates a transmission carrying the user data towards the UE 2206. The host 2202 may initiate the transmission responsive to a request transmitted by the UE 2206. The request may be caused by human interaction with the UE 2206 or by operation of the client application executing on the UE 2206. The transmission may pass via the network node 2204, in accordance with the teachings of the embodiments described throughout this disclosure. Accordingly, in step 2212, the network node 2204 transmits to the UE 2206 the user data that was carried in the transmission that the host 2202 initiated, in accordance with the teachings of the embodiments described throughout this disclosure. In step 2214, the UE 2206 receives the user data carried in the transmission, which may be performed by a client application executed on the UE 2206 associated with the host application executed by the host 2202.

In some examples, the UE 2206 executes a client application which provides user data to the host 2202. The user data may be provided in reaction or response to the data received from the host 2202. Accordingly, in step 2216, the UE 2206 may provide user data, which may be performed by executing the client application. In providing the user data, the client application may further consider user input received from the user via an input/output interface of the UE 2206. Regardless of the specific manner in which the user data was provided, the UE 2206 initiates, in step 2218, transmission of the user data towards the host 2202 via the network node 2204. In step 2220, in accordance with the teachings of the embodiments described throughout this disclosure, the network node 2204 receives user data from the UE 2206 and initiates transmission of the received user data towards the host 2202. In step 2222, the host 2202 receives the user data carried in the transmission initiated by the UE 2206.

One or more of the various embodiments improve the performance of OTT services provided to the UE 2206 using the OTT connection 2250, in which the wireless connection 2270 forms the last segment.

In an example scenario, factory status information may be collected and analyzed by the host 2202. As another example, the host 2202 may process audio and video data which may have been retrieved from a UE for use in creating maps. As another example, the host 2202 may collect and analyze real-time data to assist in controlling vehicle congestion (e.g., controlling traffic lights). As another example, the host 2202 may store surveillance video uploaded by a UE. As another example, the host 2202 may store or control access to media content such as video, audio, VR or AR which it can broadcast, multicast or unicast to UEs. As other examples, the host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2250 between the host 2202 and UE 2206, in response to variations in the measurement results. The measurement procedure and/or the network functionality for reconfiguring the OTT connection may be implemented in software and hardware of the host 2202 and/or UE 2206. In some embodiments, sensors (not shown) may be deployed in or in association with other devices through which the OTT connection 2250 passes; the sensors may participate in the measurement procedure by supplying values of the monitored quantities exemplified above, or supplying values of other physical quantities from which software may compute or estimate the monitored quantities. The reconfiguring of the OTT connection 2250 may include message format, retransmission settings, preferred routing etc.; the reconfiguring need not directly alter the operation of the network node 2204. Such procedures and functionalities may be known and practiced in the art. In certain embodiments, measurements may involve proprietary UE signaling that facilitates measurements of throughput, propagation times, latency and the like, by the host 2202. The measurements may be implemented in that software causes messages to be transmitted, in particular empty or ‘dummy’ messages, using the OTT connection 2250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless communication device (14) for discontinuous reception, DRX, operation in a wireless communication network (10), the method comprising:
receiving (1400), from the wireless communication network (10), a DRX configuration (26) that configures the wireless communication device (14) with respective durations (28) of multiple on-duration timers (15) for a DRX group, wherein the DRX group comprises one or more serving cells of the wireless communication device (14).
   A2. The method of embodiment A1, further comprising monitoring a downlink control channel (18) on the one or more serving cells if the DRX group is in active time, wherein the active time depends on the multiple on-duration timers (15).
   A3. The method of embodiment A2, wherein the active time for the DRX group includes at least time while the multiple on-duration timers (15) are running simultaneously.
   A4. The method of embodiment A2, wherein the active time for the DRX group includes time while the multiple on-duration timers (15) are running.
   A5. The method of any of embodiments A2-A4, wherein the multiple on-duration timers (15) include an inner on-duration timer (15A) and an outer on-duration timer (15B), wherein the active time for the DRX group includes at least time while the inner on-duration timer (15A) is running.
   A6. The method of embodiment A5, wherein running of the outer on-duration timer (15B) is a prerequisite for starting or re-starting the inner on-duration timer (15A).
   A7. The method of any of embodiments A5-A6, wherein stopping or expiry of the outer on-duration timer (15B) triggers prohibiting starting or re-starting the inner on-duration timer (15A) and starting or re-starting of the outer on-duration timer (15B) triggers allowing starting or re-starting the inner on-duration timer (15A).
   A8. The method of any of embodiments A5-A7, wherein stopping or expiry of the outer on-duration timer (15B) triggers stopping of the inner on-duration timer (15A).
   A9. The method of any of embodiments A5-A8, wherein stopping or expiry of the outer on-duration timer (15B) triggers stopping of an inactivity timer, wherein the active time for the DRX group also includes at least time while the inactivity timer is running.
   A10. The method of any of embodiments A5-A9, wherein receipt by the wireless communication device (14) of a stop indication from the wireless communication network (10) triggers stopping of one or more of the inner on-duration timer (15A), the outer on-duration timer (15B), and an inactivity timer.
   A11. The method of any of embodiments A1-A10, wherein the multiple on-duration timers (15) include an inner on-duration timer (15A) and an outer on-duration timer (15B).
   A12. The method of embodiment A11, further comprising, while the outer on-duration timer (15B) is running, monitoring a downlink control channel (18) on the one or more serving cells discontinuously at times when the inner on-duration timer (15A) runs.
   A13. The method of any of embodiments A11-A12, wherein the duration of the inner on-duration timer (15A) is shorter than the duration of the outer on-duration timer (15B).
   A14. The method of any of embodiments A11-A13, wherein an on-duration period of an inner DRX cycle has a duration equal to the duration of the inner on-duration timer (15A), wherein an on-duration period of an outer DRX cycle has a duration equal to the duration of the outer on-duration timer (15B), and wherein the on-duration period of an outer DRX cycle spans a set of multiple inner DRX cycles.
   A15. The method of embodiment A14, wherein the DRX configuration (26) configures different durations (28) of the inner on-duration timer (15A) for at least some inner DRX cycles in the set.
   A16. The method of any of embodiments A14-A15, wherein the DRX configuration (26) configures at least some of the inner DRX cycles in the set to have different durations (28).
   A17. The method of any of embodiments A11-A16, further comprising:
starting the outer on-duration timer (15B) if one or more outer conditions are each fulfilled; and
starting the inner on-duration timer (15A) if one or more inner conditions are each fulfilled, wherein the one or more inner conditions include a condition that the outer on-duration timer (15B) is running.
   A18. The method of any of embodiments A1-A7, wherein the multiple on-duration timers (15) include multiple inner on-duration timers (15A) and also include an outer on-duration timer (15B), wherein an on-duration period of an outer DRX cycle has a duration equal to the duration of the outer on-duration timer (15B), wherein an on-duration period of an outer DRX cycle spans a set of multiple inner DRX cycles, wherein on-duration periods of at least some of the multiple inner DRX cycles in the set have different durations (28) corresponding to the durations (28) of the multiple inner on-duration timers (15A).
   A19. The method of any of embodiments A2-A4, wherein the multiple on-duration timers (15) include an inner on-duration timer (15A) and an outer on-duration timer (15B), wherein the active time further depends on an inactivity timer, wherein the active time for the DRX group includes at least:
time while the inner and outer on-duration timers (15A, 15B) are running simultaneously; and
time while the outer on-duration timer (15B) and the inactivity timer are running simultaneously.
   A20. The method of any of embodiments A1-A19, wherein the DRX configuration (26) is specific to a certain type of service or traffic.
   A21. The method of embodiment A20, wherein the certain type of service is an extended Reality, XR, service.
   A22. The method of any of embodiments A2-A21, further comprising receiving a downlink control message on the downlink control channel (18) based on said monitoring.
   AA1. A method performed by a wireless communication device (14) for discontinuous reception, DRX, operation in a wireless communication network (10), the method comprising: starting or re-starting an inner on-duration timer (15A) if an outer on-duration timer (15B) is running; and monitoring a downlink control channel (18) at least while the inner on-duration timer (15A) is running.
   AA2. The method of embodiment AA1, wherein said monitoring comprises monitoring the downlink control channel (18) on one or more serving cells in a DRX group if the DRX group is in active time, wherein the active time includes at least time while the inner on-duration timer (15A) is running.
   AA3. The method of embodiment AA2, wherein the active time for the DRX group also includes at least time while an inactivity timer is running.
   AA4. The method of any of embodiments AA1-AA3, further comprising stopping the inner on-duration timer (15A) upon expiry of the outer on-duration timer (15B).
   AA5. The method of any of embodiments AA1-AA4, further comprising stopping an inactivity timer upon expiry of the outer on-duration timer (15B).
   AA6. The method of any of embodiments AA1-AA5, wherein said monitoring comprises, while the outer on-duration timer (15B) is running, monitoring the downlink control channel (18) discontinuously at times when the inner on-duration timer (15A) runs.
   AA7. The method of any of embodiments AA1-AA6, wherein a duration of the inner on-duration timer (15A) is shorter than a duration of the outer on-duration timer (15B).
   AA8. The method of any of embodiments AA1-AA7, wherein an inner DRX cycle comprises an on-duration period and an off-duration period, wherein the on-duration period of an inner DRX cycle has a duration equal to a duration of the inner on-duration timer (15A), wherein an outer DRX cycle comprises an on-duration period and an off-duration period, wherein the on-duration period of an outer DRX cycle has a duration equal to a duration of the outer on-duration timer (15B), and wherein the on-duration period of an outer DRX cycle spans a set of multiple inner DRX cycles.
   AA. The method of any of the previous embodiments, further comprising:
providing user data; and
forwarding the user data to a host computer via the transmission to a base station.

### Group B Embodiments

B1. A method performed by a network node (12) of configuring a wireless communication device (14) for discontinuous reception, DRX, operation in a wireless communication network (10), the method comprising:
transmitting (1300), to the wireless communication device (14), a DRX configuration (26) that configures the wireless communication device (14) with respective durations (28) of multiple on-duration timers (15) for a DRX group, wherein the DRX group comprises one or more serving cells of the wireless communication device (14).
   B2. The method of embodiment B1, wherein the multiple on-duration timers (15) govern an active time, for the DRX group, during which the wireless communication device (14) is to monitor a downlink control channel (18) on the one or more serving cells.
   B3. The method of embodiment B2, wherein the active time for the DRX group includes at least time while the multiple on-duration timers (15) are running simultaneously.
   B4. The method of embodiment B2, wherein the active time for the DRX group includes time while the multiple on-duration timers (15) are running.
   B5. The method of any of embodiments B2-B4, wherein the multiple on-duration timers (15) include an inner on-duration timer (15A) and an outer on-duration timer (15B), wherein the active time for the DRX group includes at least time while the inner on-duration timer (15A) is running.
   B6. The method of embodiment B5, wherein running of the outer on-duration timer (15B) is a prerequisite for starting or re-starting the inner on-duration timer (15A).
   B7. The method of any of embodiments B5-B6, wherein stopping or expiry of the outer on-duration timer (15B) triggers prohibiting starting or re-starting the inner on-duration timer (15A) and starting or re-starting of the outer on-duration timer (15B) triggers allowing starting or re-starting the inner on-duration timer (15A).
   B8. The method of any of embodiments B5-B7, wherein stopping or expiry of the outer on-duration timer (15B) triggers stopping of the inner on-duration timer (15A).
   B9. The method of any of embodiments B5-B8, wherein stopping or expiry of the outer on-duration timer (15B) triggers stopping of an inactivity timer, wherein the active time for the DRX group also includes at least time while the inactivity timer is running.
   B10. The method of any of embodiments B5-B9, further comprising transmitting, to the wireless communication device (14), a stop indication that indicates the wireless communication device (14) is to stop one or more of the inner on-duration timer (15A), the outer on-duration timer (15B), and an inactivity timer.
   B11. The method of any of embodiments B1-B10, wherein the multiple on-duration timers (15) include an inner on-duration timer (15A) and an outer on-duration timer (15B).
   B12. The method of embodiment B11, wherein, while the outer on-duration timer (15B) is running, the wireless communication device (14) is to monitor a downlink control channel (18) on the one or more serving cells discontinuously at times when the inner on-duration timer (15A) runs.
   B13. The method of any of embodiments B11-B12, wherein the duration of the inner on-duration timer (15A) is shorter than the duration of the outer on-duration timer (15B).
   B14. The method of any of embodiments B11-B13, wherein an on-duration period of an inner DRX cycle has a duration equal to the duration of the inner on-duration timer (15A), wherein an on-duration period of an outer DRX cycle has a duration equal to the duration of the outer on-duration timer (15B), and wherein the on-duration period of an outer DRX cycle spans a set of multiple inner DRX cycles.
   B15. The method of embodiment B14, wherein the DRX configuration (26) configures different durations (28) of the inner on-duration timer (15A) for at least some inner DRX cycles in the set.
   B16. The method of any of embodiments B14-B15, wherein the DRX configuration (26) configures at least some of the inner DRX cycles in the set to have different durations (28).
   B17. The method of any of embodiments B11-B16, wherein:
the outer on-duration timer (15B) is to be started if one or more outer conditions are each fulfilled; and
the inner on-duration timer (15A) is to be started if one or more inner conditions are each fulfilled, wherein the one or more inner conditions include a condition that the outer on-duration timer (15B) is running.
   B18. The method of any of embodiments B1-B7, wherein the multiple on-duration timers (15) include multiple inner on-duration timers (15) and also include an outer on-duration timer (15B), wherein an on-duration period of an outer DRX cycle has a duration equal to the duration of the outer on-duration timer (15B), wherein an on-duration period of an outer DRX cycle spans a set of multiple inner DRX cycles, wherein the on-duration periods of at least some of the multiple inner DRX cycles in the set have different durations (28) corresponding to the durations (28) of the multiple inner on-duration timers (15).
   B19. The method of any of embodiments B2-B4, wherein the multiple on-duration timers (15) include an inner on-duration timer (15A) and an outer on-duration timer (15B), wherein the active time further depends on an inactivity timer, wherein the active time for the DRX group includes at least:
time while the inner and outer on-duration timers (15A, 15B) are running simultaneously; and
time while the outer on-duration timer (15B) and the inactivity timer are running simultaneously.
   B20. The method of any of embodiments B1-B19, wherein the DRX configuration (26) is specific to a certain type of service or traffic.
   B21. The method of embodiment B20, wherein the certain type of service is an extended Reality, XR, service.
   B22. The method of any of embodiments B1-B21, further comprising scheduling a downlink control message to the wireless communication device (14) on the downlink control channel (18) based on the DRX configuration (26) and transmitting the scheduled downlink control message to the wireless communication device (14).
   BB. The method of any of the previous embodiments, further comprising:
obtaining user data; and
forwarding the user data to a host computer or a wireless communication device (14).

### Group C Embodiments

C1. A wireless communication device configured to perform any of the steps of any of the Group A embodiments.
C2. A wireless communication device comprising processing circuitry configured to perform any of the steps of any of the Group A embodiments.
C3. A wireless communication device comprising:
communication circuitry; and
processing circuitry configured to perform any of the steps of any of the Group A embodiments.
   C4. A wireless communication device comprising:
processing circuitry configured to perform any of the steps of any of the Group A embodiments; and
power supply circuitry configured to supply power to the wireless communication device.
   C5. A wireless communication device comprising:
processing circuitry and memory, the memory containing instructions executable by the processing circuitry whereby the wireless communication device is configured to perform any of the steps of any of the Group A embodiments.
   C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C7. A computer program comprising instructions which, when executed by at least one processor of a wireless communication device, causes the wireless communication device to carry out the steps of any of the Group A embodiments.
   C8. A carrier containing the computer program of embodiment C7, wherein the carrier is one of an electronic signal, optical signal, radio signal, or computer readable storage medium.
   C9. A network node configured to perform any of the steps of any of the Group B embodiments.
   C10. A network node comprising processing circuitry configured to perform any of the steps of any of the Group B embodiments.
   C11. A network node comprising:
communication circuitry; and
processing circuitry configured to perform any of the steps of any of the Group B embodiments.
   C12. A network node comprising:
processing circuitry configured to perform any of the steps of any of the Group B embodiments;
power supply circuitry configured to supply power to the network node.
   C13. A network node comprising:
processing circuitry and memory, the memory containing instructions executable by the processing circuitry whereby the network node is configured to perform any of the steps of any of the Group B embodiments.
   C14. The network node of any of embodiments C9-C13, wherein the network node is a base station.
   C15. A computer program comprising instructions which, when executed by at least one processor of a network node, causes the network node to carry out the steps of any of the Group B embodiments.
   C16. The computer program of embodiment C14, wherein the network node is a base station.
   C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and
at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   D28. The method of the previous embodiment, further comprising at the base station, receiving the user data from the UE.
   D29. The method of the previous 2 embodiments, further comprising at the base station, initiating a transmission of the received user data to the host computer.

### REFERENCES

1. 3GPP, TS 38.321, V16.6.0 (2021 September), Section 5.7 Discontinuous Reception (DRX).
2. 3GPP, TS 38.331, V16.6.0 (2021 September), Section 6.3.2 Radio resource control information elements.
3. 3GPP, TR 38.838, V0.1.0 (2021 October), “Study on XR (Extended Reality) Evaluations for NR”.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
DCI downlink control information
DL downlink
DRX discontinuous reception
fps frames per second
MAC Medium Access Control
MAC CE MAC Control Element
PDB packet delay budget
PDCCH physical downlink control channel
PDSCH physical downlink shared channel
UCI uplink control information
UE user equipment
UL uplink
XR extended reality
RRC Radio Resource Control
1×RTT CDMA2000 1× Radio Transmission Technology
3GPP 3^{rd} Generation Partnership Project
5G 5^{th} Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in
the band
CQ Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
Power Delay Profile PDP
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TT Transmission Time Interval
UE User Equipment
UL Uplink
Universal Subscriber Identity Module USIM
UTDOA Uplink Time Difference of Arrival
WCDMA Wide CDMA
WLAN Wide Local Area Network

1.-32. (canceled)

33. A method performed by a wireless communication device for discontinuous reception (DRX) operation in a wireless communication network, the method comprising:
receiving, from the wireless communication network, a DRX configuration that configures the wireless communication device with respective durations of multiple on-duration timers for a DRX group, wherein the DRX group comprises one or more serving cells of the wireless communication device, wherein the multiple on-duration timers include an inner on-duration timer and an outer on-duration timer, wherein running of the outer on-duration timer is a prerequisite for starting or re-starting the inner on-duration timer.

34. The method of claim 33, further comprising:
starting or re-starting the inner on-duration timer if the outer on-duration timer is running; and/or
stopping the inner on-duration timer upon expiry of the outer on-duration timer.

35. The method of claim 33, further comprising:
monitoring a downlink control channel on the one or more serving cells if the DRX group is in active time, wherein the active time for the DRX group includes at least time while the inner on-duration timer is running; and
receiving a downlink control message on the downlink control channel based on said monitoring.

36. The method of claim 35, wherein the active time further depends on an inactivity timer, wherein the active time for the DRX group includes at least:
time while the inner and outer on-duration timers are running simultaneously; and
time while the outer on-duration timer and the inactivity timer are running simultaneously.

37. The method of claim 33, further comprising, while the outer on-duration timer is running, monitoring a downlink control channel on the one or more serving cells discontinuously at times when the inner on-duration timer runs.

38. The method of claim 33, wherein receipt by the wireless communication device of a stop indication from the wireless communication network triggers stopping of one or more of the inner on-duration timer, the outer on-duration timer, and an inactivity timer.

39. The method of claim 33, wherein the duration of the inner on-duration timer is shorter than the duration of the outer on-duration timer.

40. The method of claim 33, wherein an on-duration period of an inner DRX cycle has a duration equal to the duration of the inner on-duration timer, wherein an on-duration period of an outer DRX cycle has a duration equal to the duration of the outer on-duration timer, and wherein the on-duration period of an outer DRX cycle spans a set of multiple inner DRX cycles.

41. The method of claim 33, wherein the multiple on-duration timers include multiple inner on-duration timers, wherein an on-duration period of an outer DRX cycle has a duration equal to the duration of the outer on-duration timer, wherein an on-duration period of an outer DRX cycle spans a set of multiple inner DRX cycles, wherein on-duration periods of at least some of the multiple inner DRX cycles in the set have different durations corresponding to the durations of the multiple inner on-duration timers.

42. A method performed by a network node of configuring a wireless communication device for discontinuous reception (DRX) operation in a wireless communication network, the method comprising:
transmitting, to the wireless communication device, a DRX configuration that configures the wireless communication device with respective durations of multiple on-duration timers for a DRX group, wherein the DRX group comprises one or more serving cells of the wireless communication device, wherein the multiple on-duration timers include an inner on-duration timer and an outer on-duration timer, wherein running of the outer on-duration timer is a prerequisite for starting or re-starting the inner on-duration timer.

43. A wireless communication device for discontinuous reception (DRX) operation in a wireless communication network, wherein the wireless communication device comprises:
communication circuitry; and
processing circuitry configured to receive, from the wireless communication network, a DRX configuration that configures the wireless communication device with respective durations of multiple on-duration timers for a DRX group, wherein the DRX group comprises one or more serving cells of the wireless communication device, wherein the multiple on-duration timers include an inner on-duration timer and an outer on-duration timer, wherein running of the outer on-duration timer is a prerequisite for starting or re-starting the inner on-duration timer.

44. The wireless communication device of claim 43, wherein the processing circuitry is further configured to:
start or re-start the inner on-duration timer if the outer on-duration timer is running; and/or
stop the inner on-duration timer upon expiry of the outer on-duration timer.

45. The wireless communication device of claim 43, wherein the processing circuitry is further configured to:
monitor a downlink control channel on the one or more serving cells if the DRX group is in active time, wherein the active time for the DRX group includes at least time while the inner on-duration timer is running; and
receive a downlink control message on the downlink control channel based on said monitoring.

46. The wireless communication device of claim 45, wherein the active time further depends on an inactivity timer, wherein the active time for the DRX group includes at least:
time while the inner and outer on-duration timers are running simultaneously; and
time while the outer on-duration timer and the inactivity timer are running simultaneously.

47. The wireless communication device of claim 43, wherein the processing circuitry is further configured to, while the outer on-duration timer is running, monitor a downlink control channel on the one or more serving cells discontinuously at times when the inner on-duration timer runs.

48. The wireless communication device of claim 43, wherein receipt by the wireless communication device of a stop indication from the wireless communication network triggers stopping of one or more of the inner on-duration timer, the outer on-duration timer, and an inactivity timer.

49. The wireless communication device of claim 43, wherein the duration of the inner on-duration timer is shorter than the duration of the outer on-duration timer.

50. The wireless communication device of claim 43, wherein an on-duration period of an inner DRX cycle has a duration equal to the duration of the inner on-duration timer, wherein an on-duration period of an outer DRX cycle has a duration equal to the duration of the outer on-duration timer, and wherein the on-duration period of an outer DRX cycle spans a set of multiple inner DRX cycles.

51. The wireless communication device of claim 43, wherein the multiple on-duration timers include multiple inner on-duration timers, wherein an on-duration period of an outer DRX cycle has a duration equal to the duration of the outer on-duration timer, wherein an on-duration period of an outer DRX cycle spans a set of multiple inner DRX cycles, wherein on-duration periods of at least some of the multiple inner DRX cycles in the set have different durations corresponding to the durations of the multiple inner on-duration timers.

52. A network node of configuring a wireless communication device for discontinuous reception (DRX) operation in a wireless communication network, the network node comprising:
communication circuitry; and
processing circuitry configured to transmit, to the wireless communication device, a DRX configuration that configures the wireless communication device with respective durations of multiple on-duration timers for a DRX group, wherein the DRX group comprises one or more serving cells of the wireless communication device, wherein the multiple on-duration timers include an inner on-duration timer and an outer on-duration timer, wherein running of the outer on-duration timer is a prerequisite for starting or re-starting the inner on-duration timer.
